(19) United States
(12) Patent Application Publication
(10) Pub. No.: US 2026/0037957 A1
(43) Pub. Date: Feb. 5, 2026

(54) SYSTEMS AND METHODS FOR LINKING A DIGITAL WALLET WITHIN A SEPARATE PAYMENT SERVICE

(71) Applicant: Early Warning Services, LLC, Scottsdale, AZ (US)

(72) Inventors: John Mwangi, West Orange, NJ (US); Graham Ritter, New York, NY (US); Rajesh Kulkami, Scottsdale, AZ (US); Christian Faragalli, New York, NY (US); Lawrence Hutchison Douglas, JR., McLean, VA (US)

(73) Assignee: Early Warning Services, LLC, Scottsdale, AZ (US)

(21) Appl. No.: 19/288,434

(22) Filed: Aug. 1, 2025

Related U.S. Application Data
(60) Provisional application No. 63/678,320, filed on Aug. 1, 2024.

(51) Int. Cl. G06Q 20/36; G06Q 20/12; G06Q 20/22; G06Q 20/34; G06Q 20/40

(52) U.S. Cl. CPC G06Q 20/36; G06Q 20/12; G06Q 20/351; G06Q 20/4014; G06Q 20/227

(57) ABSTRACT

A computer-implemented method including determining, by a wallet server, whether a wallet of a user can be linked to a payment service account of the user. The method also can include causing a link option to be displayed to the user on a wallet user interface. The method additionally can include receiving, at the wallet server from the wallet user interface, a request to link the wallet to the payment service account. The method further can include sending, by the wallet server, card information for one or more payment cards in the wallet to a payment service server be added to the payment service account. Other embodiments are described.

### CROSS-REFERENCE TO RELATED APPLICATION

This application claims the benefit of U.S. Provisional Application No. 63/678,320, filed Aug. 1, 2024. U.S. Provisional Application No. 63/678,320 is incorporated herein by reference in its entirety.

### TECHNICAL FIELD

This disclosure relates generally to linking a digital wallet within a separate payment service.

### BACKGROUND

Conventional online checkout typically involves a user providing card details to the merchant for the transaction. The merchant often provides the option to store the card information so that the user is not asked for the card information the next time the user does an online checkout at the same merchant. User often have multiple different cards, which are often issued by multiple different card issuers. Additionally, users often use websites of many different merchants, each with their own checkout system.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for linking a digital wallet within a separate payment service, according to an embodiment;

FIG. 4 illustrates a flow diagram of a data flow between the payment service server of FIG. 3 and the wallet server of FIG. 3 to determine eligibility for linkage of a wallet of the user in the wallet server to a payment service account of the user in the payment service server;

FIG. 5 illustrates a flow diagram of a data flow between the payment service server of FIG. 3 and the wallet server of FIG. 3 to perform a linkage of the wallet of the user in the wallet server to the payment service account of the user in the payment service server;

FIG. 6 illustrates a flow diagram of a data flow between payment service server of FIG. 3 and the wallet server of FIG. 3 to perform linkage lifecycle management of the wallet of the user in the wallet server with the payment service account of the user in the payment service server;

FIG. 7 illustrates a flow diagram of a data flow between various system components of the system of FIG. 3 to initiate a purchase through the payment service provided by the payment service server of FIG. 3 based on a card that is linked from the wallet provided by the wallet server or FIG. 3;

FIG. 8A illustrates an exemplary display screen of a graphical user interface of a website of a merchant displayed on a user device used by a user to initiate a checkout process that facilitates a purchase using a new card entered into a browser;

FIG. 8B illustrates an exemplary prompt that can be displayed on the browser to prompt the user to save a card to the payment service account of the user;

FIG. 8C illustrates an exemplary prompt that can be displayed on the browser to prompt the user to convert the card entered to a virtual card;

FIG. 9A illustrates an exemplary display screen of a graphical user interface of a website of a merchant displayed on a user device used by a user to initiate a checkout process that facilitates a purchase using a card already saved in a browser;

FIG. 9B illustrates an exemplary display screen of a graphical user interface of the merchant after a successful transaction, including a prompt displayed on the browser to prompt the user to convert the card entered to a virtual card;

FIG. 10A illustrates an exemplary display screen of a graphical user interface of a website provided by the payment service server of FIG. 3, which can be a payment service management website for the user to manage the payment service account of the user in the payment service server;

FIG. 10B illustrates an exemplary prompt that can be displayed by the payment service server to allow the user to save the card as a virtual card;

FIG. 11 illustrates an exemplary display screen of a welcome screen for the wallet service provided by the wallet server of FIG. 3;

FIG. 12 illustrates an exemplary display screen that can be shown after the user selects the continue button of FIG. 11, to allow the user to enter an authentication code;

FIG. 13 illustrates an exemplary display screen that can be shown after the user enters the authentication code in the display screen of FIG. 12, showing that the code is being verified;

FIG. 14 illustrates an exemplary display screen that shows a wallet page showing card information of cards in a wallet of a user;

FIG. 15 illustrates an exemplary display screen that shows a profile page showing profile information and options for the user associated with the wallet shown in FIG. 14;

FIG. 16 illustrates an exemplary display screen that shows information about linking the wallet to a payment service account;

FIG. 17 illustrates an exemplary display screen that prompts the user to sign in to the payment service account of the user;

FIG. 18 illustrates an exemplary display screen that shows additional information about linking the wallet to a payment service account and prompts the user to link the wallet to the payment service account;

FIG. 19 illustrates an exemplary display screen that shows that the linking was successful;

FIG. 20 illustrates an exemplary display screen that shows a profile page showing profile information and options for the user associated with the wallet, after the wallet has been linked to the payment service account;

FIG. 21 illustrates an exemplary display screen that shows a login screen for a banking app;

FIG. 22 illustrates an exemplary display screen of the banking app that shows a home screen for the banking app;

FIG. 23 illustrates an exemplary display screen of the banking app that displays information about the wallet service.

FIG. 24 illustrates an exemplary display screen of a welcome screen for the wallet service provided by the wallet server of FIG. 3;

FIG. 25 illustrates an exemplary display screen showing information about the wallet service;

FIG. 26 illustrates an exemplary display screen of a merchant that can be displayed when the user initiates a checkout process that facilitates a purchase, such as by selecting a checkout button on a merchant webpage;

FIG. 27 illustrates an exemplary display screen that shows an update of the display screen of FIG. 26, showing that the user can enter new card information;

FIG. 28 illustrates an exemplary display screen that is an update of the display screen of FIG. 27, showing the payment information having been received by the merchant;

FIG. 29 illustrates a display screen that is an update of the display screen of FIG. 28, which includes an exemplary prompt that can be displayed on the browser to prompt the user to link the wallet of the user to the payment service account of the user;

FIG. 30 illustrates a display screen that is an update of the display screen of FIG. 29, which includes a verification code prompt that asks the user to enter the code sent to the mobile phone of the user in an input field;

FIG. 31 illustrates a display screen that is an update of the display screen of FIG. 30, which includes a notification that the linkage of the wallet of the user in the wallet server of FIG. 3 to the payment service account of the user in the payment service server of FIG. 3 is successful;

FIG. 32 illustrates a display screen that can be displayed when the user initiates a checkout process that facilitates a purchase, such as by selecting a checkout button on a merchant webpage;

FIG. 33 illustrates a display screen that is an update of the display screen of FIG. FIG. 30, which includes a prompt to confirm the cards in the wallet to be linked to the payment service account;

FIG. 34 illustrates a sequence diagram of a method of linking a wallet to a payment service account through a wallet management user interface provided by a wallet server, according to an embodiment;

FIG. 35 illustrates a sequence diagram of a method of linking a wallet to a payment service account through a payment service user interface provided by a payment service server, according to an embodiment;

FIG. 36 illustrates a sequence diagram of a method of processing a checkout using the payment service, according to an embodiment;

FIG. 37 illustrates a flowchart for a method of linking a digital wallet within a separate payment service, according to an embodiment; and

FIG. 38 illustrates a flowchart for a method of linking a digital wallet within a separate payment service, according to an embodiment.

For simplicity and clarity of illustration, the drawing figures herein illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, two minutes, or five minutes.

### DESCRIPTION OF EXAMPLES OF EMBODIMENTS

Various embodiments include a computer-implemented method. The method can include determining, by a wallet server, whether a wallet of a user can be linked to a payment service account of the user. The method also can include causing a link option to be displayed to the user on a wallet user interface. The method additionally can include receiving, at the wallet server from the wallet user interface, a request to link the wallet to the payment service account. The method further can include sending, by the wallet server, card information for one or more payment cards in the wallet to a payment service server be added to the payment service account.

A number of embodiments include a system including one or more processors and one or more non-transitory computer-readable media storing computing instructions that, when executed on the one or more processors, cause the one or more processors to perform operations. The operations can include determining, by a wallet server, whether a wallet of a user can be linked to a payment service account of the user. The operations also can include causing a link option to be displayed to the user on a wallet user interface. The operations additionally can include receiving, at the wallet server from the wallet user interface, a request to link the wallet to the payment service account. The operations further can include sending, by the wallet server, card information for one or more payment cards in the wallet to a payment service server be added to the payment service account.

Further embodiments include one or more non-transitory computer-readable media storing computing instructions that, when executed on the one or more processors, cause the one or more processors to perform operations. The operations can include determining, by a wallet server, whether a wallet of a user can be linked to a payment service account of the user. The operations also can include causing a link option to be displayed to the user on a wallet user interface. The operations additionally can include receiving, at the wallet server from the wallet user interface, a request to link the wallet to the payment service account. The operations further can include sending, by the wallet server, card information for one or more payment cards in the wallet to a payment service server be added to the payment service account.

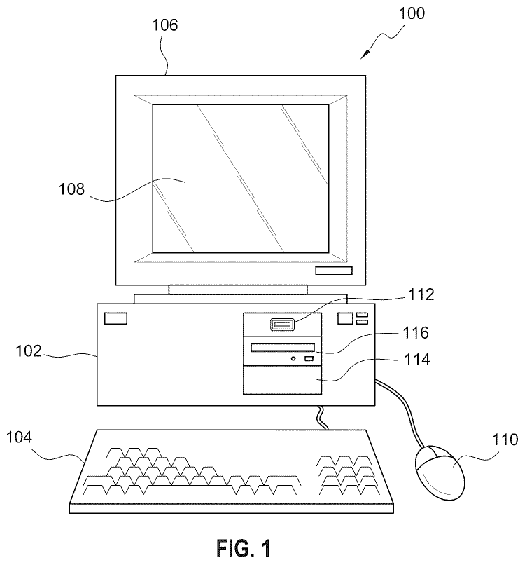

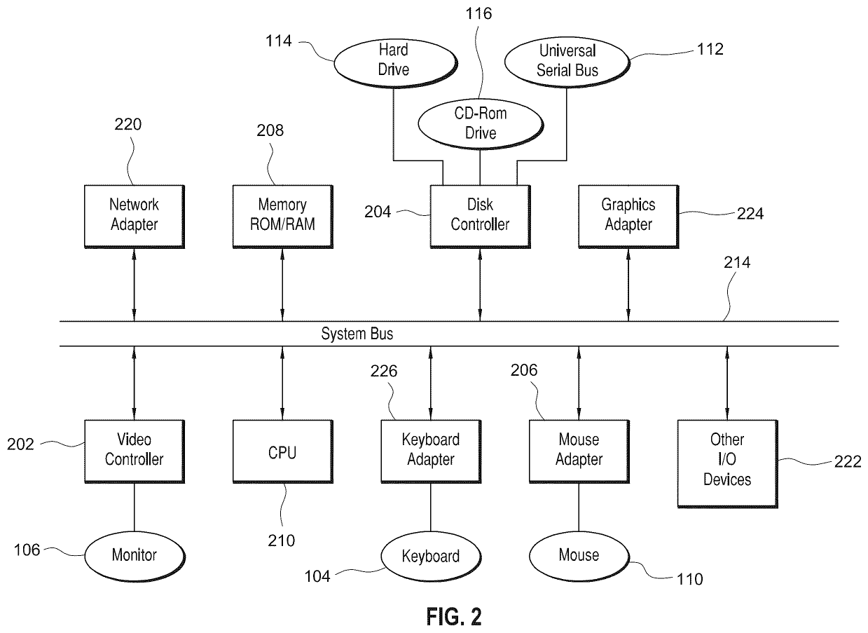

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) or Field Programmable Gate Arrays (FPGAs) can be programmed to carry out one or more of the systems and procedures described herein. For example, one or more of the programs and/or executable program components described herein can be implemented in one or more ASICs or FPGAs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

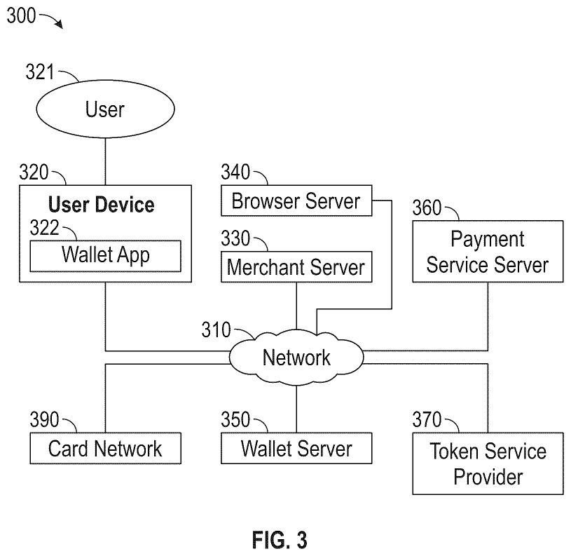

Turning ahead in the drawings, FIG. 3 illustrates a block diagram of a system 300 that can be employed for linking a digital wallet within a separate payment service, according to an embodiment. System 300 is merely exemplary, and embodiments of the system are not limited to the embodiments presented herein. The system can be employed in many different embodiments or examples not specifically depicted or described herein. In some embodiments, certain elements of system 300 can perform various procedures, processes, and/or activities. In other embodiments, the procedures, processes, and/or activities can be performed by other suitable elements of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include various systems, such as one or more user devices (e.g., user device 320) used by one or more users (e.g., user 321), one or more merchant servers (e.g., merchant server 330), one or more browser servers (e.g., browser server 340), a wallet server 350, one or more payment service servers (e.g., payment service server 360), one or more token service providers (e.g., token service provider 370), and one or more card networks (e.g., card network 390). In some embodiments, the systems of system 300 can be in data communication with each other through a network 310. Network 310 can be the Internet or another suitable network, or multiple different networks. In some embodiments, network 310 can be public or private, or can include one or more public networks and one or more private networks.

The systems of system 300, such as user device 320, merchant server 330, browser server 340, wallet server 350, payment service server 360, token service provider 370, and/or card network 390, can each be a computer system, such as computer system 100 (FIG. 1), as described above, and can each be a single computer, a single server, or a cluster or collection of computers or servers, or a cloud of computers or servers. In another embodiment, a single computer system can host multiple systems of system 300. In some embodiments, wallet server 350 can be provided and/or operated by an entity that is different from the entities operating merchant server 330, browser server 340, payment service server 360, token service provider 370, and/or card network 390.

In many embodiments, merchant server 330 can be operated by one or more merchants, which can host one or more websites and/or application servers. For example, merchant server 330 can host a website, or provide a server that interfaces with an application (e.g., a mobile application), on user device 320, which can allow users 321 (e.g., consumers) to search for items (e.g., products, grocery items), to add items to an electronic cart, and/or to purchase items through an online merchant checkout process, in addition to other suitable activities. The website hosted by merchant server 330 can provide a payment application to users 321 using user devices 320. The payment application can provide the online merchant checkout process to user devices 320, to allow user 321 to make a purchase or complete a transaction.

User device 320 can run a web browser or mobile application to view the various pages of the website and/or payment application. For example, the browser can be any suitable browser, such as Google Chrome, Microsoft Edge, Apple Safari, Mozilla Firefox, etc. In many embodiments, browser server 340 can be associated with a particular type of browser. For example, a Google browser server can be associated with the Google Chrome web browser, and a Microsoft browser server can be associated with the Microsoft Edge web browser.

In many embodiments, wallet server 350 can provide wallet services to provide a shared wallet for multiple payment cards (e.g., credit cards, debit cards, etc.), such as from various different issuers. The payment cards each can be associated with a particular card network (e.g., card network 390). For example, a first payment card can be associated with the first card network, and a second payment card can be associated with the second card network. The first payment card can be provided by a different issuer than the second payment card, and/or the first card network can be different from the second card network. In several embodiments, wallet server 350 can provide wallet services to multiple different merchants (individually or simultaneously), each using a merchant server (e.g., 330).

In certain embodiments, user devices 320 can be desktop computers, laptop computers, mobile devices, and/or other endpoint devices used by one or more users (e.g., user 321). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, and/or (ii) the Android™ operating system developed by the Open Handset Alliance.

In many embodiments, the systems of system 300 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the systems of system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of the system of systems 300. In a similar manner, the processors and/or the non-transitory computer-readable media can be local and/or remote to each other.

Meanwhile, in many embodiments, the systems of system 300 also can be configured to communicate with one or more databases. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, the systems of system 300, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In a number of embodiments, card network 390 can be operated by card networks (e.g., Visa, MasterCard, Discover, American Express, etc.). Card networks 390 can facilitate transactions between merchants (e.g., merchants operating merchant servers (e.g., 330)) and issuers by interfacing with token service providers (e.g., token service provider 370). Token service provider 370 can provide token services, such as tokenizing payment cards and/or provision of such tokens.

In various embodiments, wallet server 350 can create and/or store a wallet for each user (e.g., 321) in a wallet directory. The wallet directory can include a single shared wallet for a user (e.g., 321) that can be used for multiple different payment cards associated with the user, including multiple cards from different issuers. In many embodiments, the user can be identified based on the email address, phone number, and/or other identifying information of the user, so that a merchant can provide the email address, phone number, and/or other identifying information of the user to the wallet server 350 to access the cards associated with the user in wallet server 350. In many embodiments, a wallet directory can be centralized, so that it handles payment cards across multiple issuers. In many embodiments, wallet server 350 can provide the wallet services, such as delivering payment credentials to merchant server 330. For example, the wallet services can be the Paze service provided by Early Warning Services, LLC, of Scottsdale, Arizona, or another suitable wallet service.

In many embodiments, payment service server 360 can provide a payment service, such as a mobile payment service, which can be associated with a wallet app (application) 322 on user device 320, and/or with a web-based interface accessible on user device 320. Examples of the payment service include Google Pay (which is associated with the Google Wallet app), Apple Pay (which is associated with the Apple Wallet app), Samsung Pay (which is associated with the Samsung Wallet app), Amazon Pay (which is associated with the Amazon Wallet app), etc. In many embodiments, the payment service can create a respective account for each user for use with the wallet app 322 and/or another interface (e.g., a web-based interface). The account can store one or more payment instruments, such as payment cards, which can be accessed and used during a transaction through wallet app 322, as a digital wallet, and/or another interface (e.g., a web-based interface). In some examples, payment service server 360 and browser server 340 can be operated by the same or affiliated entities. For example, Google Pay and Google Chrome can be operated by the Google LLC or its affiliated entities. Similarly, Apple Pay and Apple Safari can be operated by Apple Inc. or its affiliated entities.

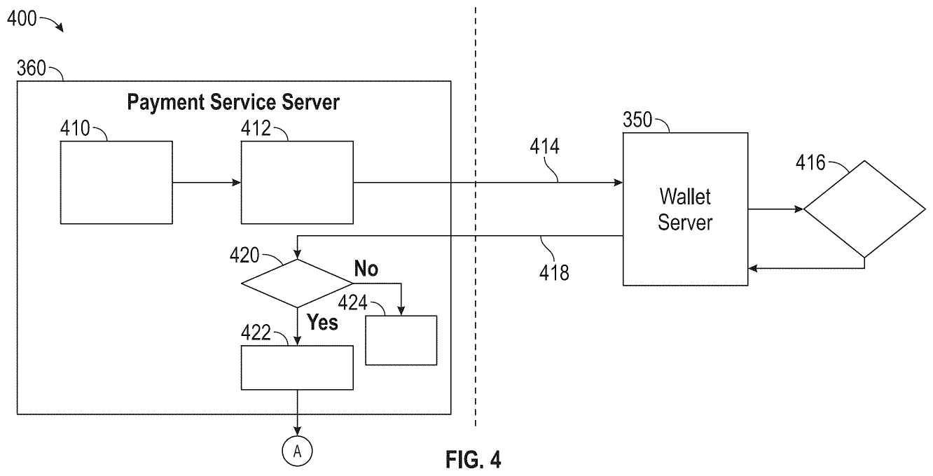

Turning ahead in the drawings, FIG. 4 illustrates a flow diagram of a data flow 400 between payment service server 360 and wallet server 350 to determine eligibility for linkage of a wallet of the user in wallet server 350 to a payment service account of the user in payment service server 360. Data flow 400 is merely exemplary and is not limited to the embodiments presented herein. Data flow 400 can be employed in many different embodiments or examples not specifically depicted or described herein. In some embodiments, the procedures, the processes, and/or the activities of data flow 400 can be performed in the order presented. In other embodiments, the procedures, the processes, and/or the activities of data flow 400 can be performed in any suitable order. In still other embodiments, one or more of the procedures, the processes, and/or the activities of data flow 400 can be combined or skipped.

In many embodiments, system 300 and/or the components thereof, such as payment service server 360 and wallet server 350, can be suitable to perform data flow 400 and/or one or more of the operations, actions, and/or activities of data flow 400. In these or other embodiments, one or more of the operations, actions, and/or activities of data flow 400 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

In many embodiments, data flow 400 can include an activity 410 of authentication. In many embodiments, when a user (e.g., 321 (FIG. 3)) seeks to access the payment service account of the user, activity 410 of authentication can be performed to ensure that the user is the one attempting to access the account. For example, the user (e.g., 321 (FIG. 3)) using user device 320 (FIG. 3)) can access the payment service server 360 through a wallet app (e.g., 322 (FIG. 3)) associated with payment service server 360, a web-based interface, or another suitable interface. The authentication can be performed through login credentials and/or additional authentication, such as two-factor authentication, etc. Next, after the user is logged into the payment service account of the user, data flow 400 can in an activity 412 of payment service server 360 initiating a determination of whether the user has a wallet account with wallet server 350 that is eligible for linkage with the payment service account. In many embodiments, payment service server 360 can provide unique contact information 414 (e.g., email, phone number, and/or other identifying information) for the user to wallet server 350.

In many embodiments, data flow 400 next can include an activity 416 of wallet server 350 determining whether there is an eligible wallet for the user. In many embodiments, activity 416 can include a look-up based on the contact information, such as email, phone number, and/or other identifying information, to search for a wallet. If the email, phone number, and/or other identifying information matches with at least one wallet, then an eligibility check and can be performed, and if not, the eligibility check is not performed. For the eligibility check, in many embodiments, wallet server 350 can determine whether the user can checkout using an eligible wallet by identifying a wallet associated with the user, determining whether the wallet is in a valid and/or active state, determining whether one or more cards are present in the wallet, and/or determining whether the one or more cards are eligible cards and can be used for a transaction. Next, in many embodiments, wallet server 350 can provide a response 418 to payment service server 360. If there is an eligible wallet, response 418 can include a success indicator and/or the wallet ID (identifier) for the wallet of the user. Otherwise, response 418 can include a failure indicator if a wallet is not found or the found wallet is not an eligible wallet.

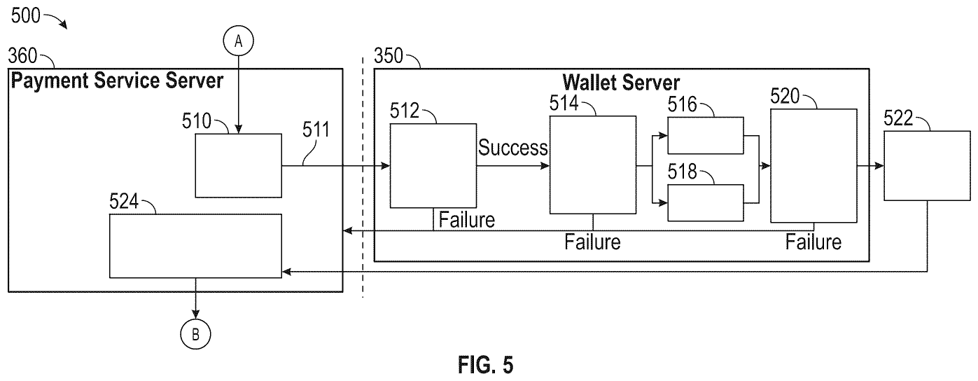

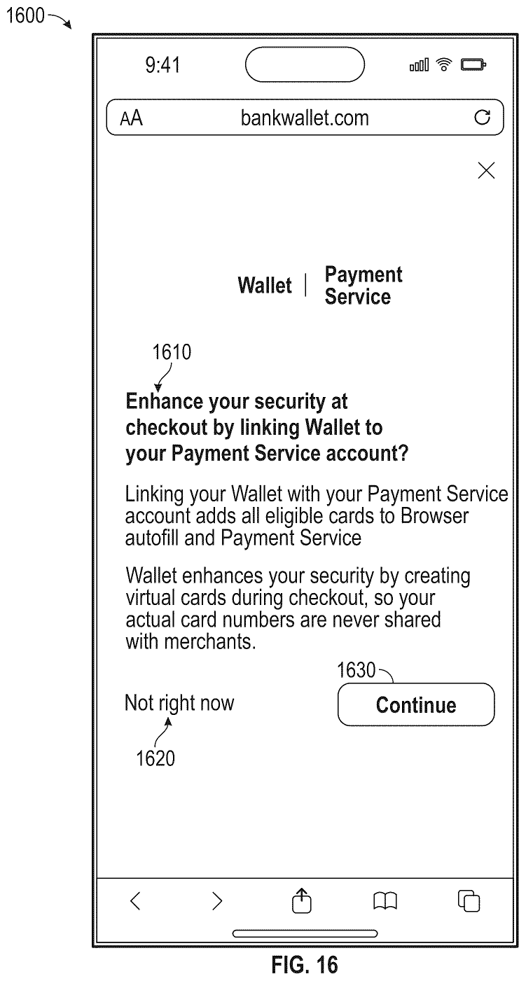

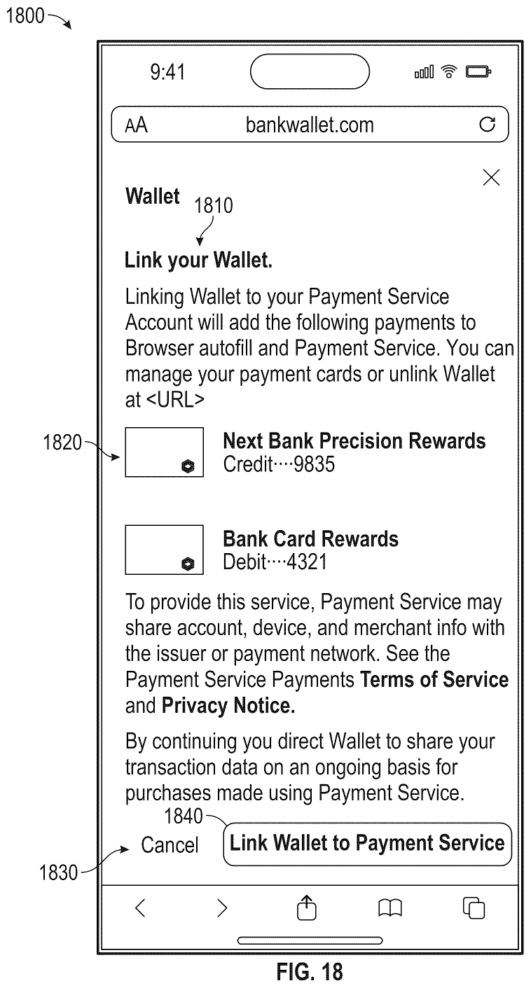

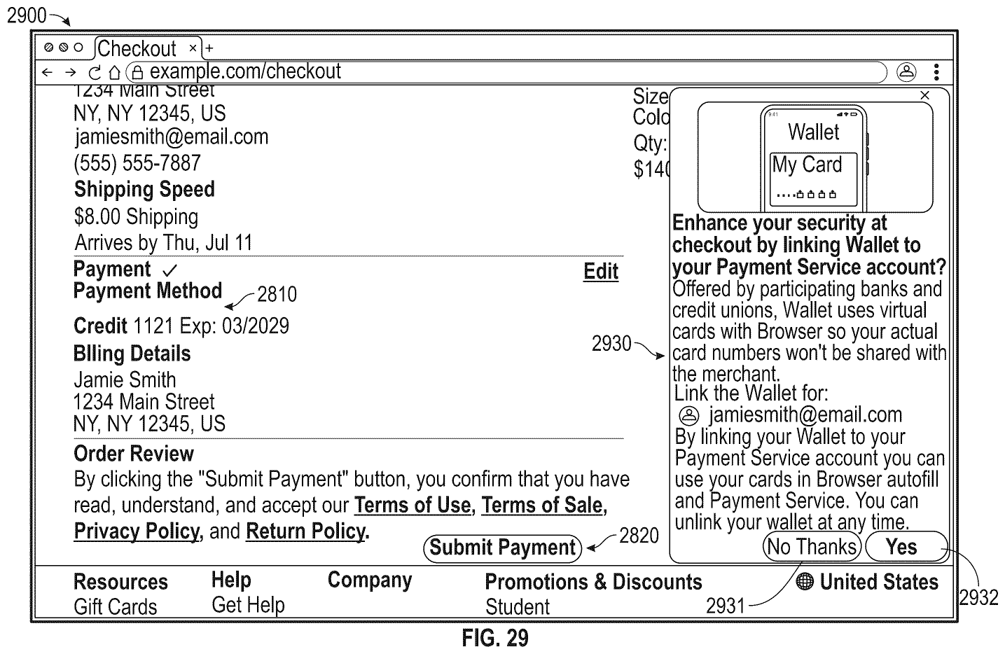

Next, in many embodiments, data flow 400 can include payment service server 360 performing an activity 420 of determining if the eligibility determination is successful. If the result of activity 420 is yes, data flow 400 can proceed to an activity 422 of payment service server 360 displaying a “Link to Wallet” option to the user (such as shown in display screen 1600 (FIG. 16), display screen 1800 (FIG. 18), and/or prompt 2930 (FIG. 29), described below). The “Link to Wallet” option can be displayed to the user via the interface on user device 320 (FIG. 3)) through which the user is accessing payment service server 360 (FIG. 3), such as through wallet app 322 (FIG. 3), a web-based interface, or another suitable interface. In many embodiments, the “Link to Wallet” option can allow the user to link the wallet of the user in wallet server 350 with the payment service account for the user in payment service server 360. In some embodiments, activity 422 of displaying a “Link to Wallet” option can include displaying information to the user about linking the wallet to the payment service. In some embodiments, the user can be presented with a selectable button or option to allow the user to select the “Link to Wallet” option, as described below in connection with activity 510 of FIG. 5. Otherwise, if the result of activity 420 is no, data flow 400 can proceed to an activity 424 of payment service server 360 not displaying the “Link to Wallet” option.

Turning ahead in the drawings, FIG. 5 illustrates a flow diagram of a data flow 500 between payment service server 360 and wallet server 350 to perform a linkage of the wallet of the user in wallet server 350 to the payment service account of the user in payment service server 360. Data flow 500 is merely exemplary and is not limited to the embodiments presented herein. Data flow 500 can be employed in many different embodiments or examples not specifically depicted or described herein. In some embodiments, the procedures, the processes, and/or the activities of data flow 500 can be performed in the order presented. In other embodiments, the procedures, the processes, and/or the activities of data flow 500 can be performed in any suitable order. In still other embodiments, one or more of the procedures, the processes, and/or the activities of data flow 500 can be combined or skipped.

In many embodiments, system 300 and/or the components thereof, such as payment service server 360 and wallet server 350, can be suitable to perform data flow 500 and/or one or more of the operations, actions, and/or activities of data flow 500. In these or other embodiments, one or more of the operations, actions, and/or activities of data flow 500 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

In many embodiments, data flow 500 can include an activity 510 of the user selecting “Link to Wallet” option. In many embodiments, the user can select the “Link to Wallet” option via the interface on user device 320 (FIG. 3)) through which the user is accessing payment service server 360 (FIG. 3), such as through wallet app 322 (FIG. 3), a web-based interface, or another suitable interface. Next, in many embodiments, payment service server 360 can make a call 511 to wallet server 350, to send the contact information and/or wallet ID to wallet server 350. In many embodiments, call 511 can launch an experience (e.g., a web-based experience) hosted by wallet server 350 on user device 320 (FIG. 3).

In some embodiments, wallet server 350 can determine how many wallets were found eligible for the user in data flow 400 (FIG. 4). If the linkage determination in data flow 400 (FIG. 4) matched one wallet, the data flow 500 can proceed to an activity 512 of presenting one or more service agreements to the user. If the linkage determination in data flow 400 (FIG. 4) matched multiple wallets, then additional pieces of the contact information can be used to attempt to disambiguate the wallet. For example, if the email address matched to multiple wallets, and the phone number disambiguates to one wallet, then that one wallet associated with and identified by the email address and phone number can be used, the data flow 500 can proceed to activity 512. In many embodiments, it will be understood that other identifying information of the user can be used in addition to or alternative to the email address and/or phone number to disambiguate the wallet. If the contact information cannot be used to successfully disambiguate to one wallet, then wallet server 350 can perform a wallet disambiguation, which can involve prompting the user to enter additional contact information, which can be used to disambiguate. On successful disambiguation, data flow 500 can proceed to activity 512.

At activity 512, the user can be presented with one or more service agreements. If the user had previously signed up for wallet service (e.g., claimed the wallet of the user) in wallet server 350, then the user can be presented with a service agreement for linking the wallet to the payment service account. Otherwise, if the user had not previously claimed the wallet, then the user can be presented with a service agreement to sign up for the wallet service, and a service agreement to link the wallet to the payment service account. Once the user has accepted the terms and conditions of the one or more service agreements, wallet server 350 can proceed to an activity 514 of device recognition and/or third-party vendor checks. Otherwise, if the user cancels out of the service agreement, wallet server 350 can return control to payment service server 360.

At activity 514, wallet server can determine whether the device is recognized as a device associated with the user and/or perform one or more third-party vendor checks, after which wallet server 350 can attempt to authenticate the user through the experience (e.g., web-based experience) hosted by wallet server 350 on user device 320 (FIG. 3). For example, in some embodiments, if the device is a recognized device, data flow 500 can include an activity 516 of sending a one-time passcode (OTP) via text message (e.g., SMS (short message service)) to the phone number associated with the user to authenticate the user and asking the user to verify the OTP, and/or if the device is an unrecognized device, data flow 500 can include an activity 518 of verifying an OTP and/or asking the user to provide one or more verification values associated with one or more of the cards in the wallet of the user, upon which wallet server 350 can verify whether the one or more verification values provided match those stored in the wallet. The verification value can be a security and/or verification measure used by the card network. For example, a card verification value (CVV) is a multi-digit code used for verification by the Visa card network and a card verification code (CVC) is a multi-digit code used for verification by the Mastercard card network. In addition, or alternatively, one or more third-party authentication procedures can be used, such as Passkey provided by Google or another suitable authentication service. In some embodiments, if the authentication fails, wallet server 350 can return to payment service server 360, and in some embodiments can present a selectable button or option to the user to return control to payment service server 360.

On successful authentication, data flow 500 can include an activity 520 of wallet server 350 displaying a confirmation page to the user. In some embodiments, the confirmation page can display cards in the wallet to be linked to the payment service account. In some embodiments, upon selecting each card, the user can be prompted to enter the respective verification value (e.g., CVV, CVC) associated with the respective card, as a step-up authentication. In some embodiments, some cards can be eligible for linkage, while other cards may not be eligible for linkage, such as due to trust settings provided by the issuer of a particular card. In some embodiments, the cards that are not eligible can be displayed as not eligible, and one or more of the reasons for not being eligible can be displayed, and in some cases, the user can be presented with one or more ways to resolve the one or more issues preventing the card(s) from being eligible for linkage. In many embodiments, once the user has selected the cards to be linked, the user can click on a linkage button or other selectable option to confirm the linkage of the selected cards. After the user has confirmed the linkage, card information 522 (e.g., information about the eligible and selected cards) can be provided by wallet server 350 to payment service server 360. In many embodiments, card information 522 returned can include an autofill token (e.g., virtual card number) for each card created by wallet server 350 (or requested from card network 390 (FIG. 3) and/or token service provider 370 (FIG. 3) by wallet server 350), card art associated with the payment card, an expiration date of the payment card, the last four digits of the actual primary account number (PAN) of the payment card, a payment card ID, a payment account reference number and/or other suitable information.

In many embodiments, data flow 500 next can include an activity 524 of payment service server 360 displaying one or more payment cards from the wallet. In many embodiments, payment service server 360 can display the cards contributed from the wallet with an icon or other description associated with the wallet service provided by wallet server 350.

In a number of embodiments, payment service server 360 can suppress, delete, or otherwise withhold duplicate cards in the payment service account of the user and/or the wallet of the user. For example, if the payment service account of the user already includes a card that matches one of the cards sent from wallet server 350, the card entered in the payment service account of the user by using the PAN of the card can be suppressed, deleted, or otherwise withheld from the payment service account, as the card in the wallet can use a token (virtual card number), which can provide additional security. Later, if the user attempts to add a new card to the payment service account in payment service server 360 and that card already exists in the wallet of the user in wallet server 350 and is linked to the payment service account of the user, then the addition of the new card to the payment service account can be suppressed or not added because that card is already linked to the payment service account. If the user attempts to add a new card to the wallet of the user in wallet server 350, and that card already exists in the payment service account of user in payment service server 360, then the card instance in the payment service account of the user can be suppressed, deleted, or otherwise withheld from the payment service account. In some embodiments, payment service server 360 can provide a payload to wallet server 350 with account-level information user for risk profiling.

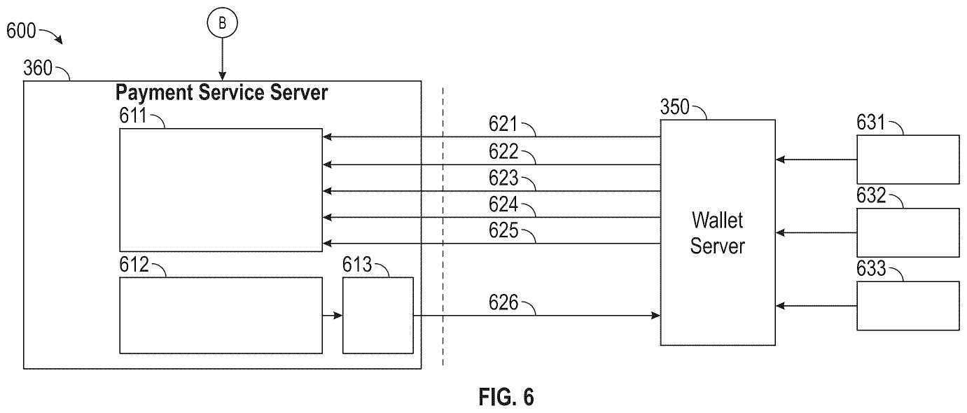

Turning ahead in the drawings, FIG. 6 illustrates a flow diagram of a data flow 600 between payment service server 360 and wallet server 350 to perform linkage lifecycle management of the wallet of the user in wallet server 350 with the payment service account of the user in payment service server 360. Data flow 600 is merely exemplary and is not limited to the embodiments presented herein. Data flow 600 can be employed in many different embodiments or examples not specifically depicted or described herein. In some embodiments, the procedures, the processes, and/or the activities of data flow 600 can be performed in the order presented. In other embodiments, the procedures, the processes, and/or the activities of data flow 600 can be performed in any suitable order. In still other embodiments, one or more of the procedures, the processes, and/or the activities of data flow 600 can be combined or skipped.

In many embodiments, system 300 and/or the components thereof, such as payment service server 360 and wallet server 350, can be suitable to perform data flow 600 and/or one or more of the operations, actions, and/or activities of data flow 600. In these or other embodiments, one or more of the operations, actions, and/or activities of data flow 600 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

In many embodiments, data flow 600 can include various different actions that can be initiated by the user or other events. For example, the user can initiate an activity 612 of unlinking the accounts (the wallet of the user and the payment service account of the user) through payment service server 360. The user can access options provided by payment service server 360 via an interface on user device 320 (FIG. 3)), such as through wallet app 322 (FIG. 3), a web-based interface, or another suitable interface. In many embodiments, after the user has initiated the unlinking, payment service server 360 can perform an activity 613 of purging data associated with the wallet of the user that has been provided to payment service server 360 from wallet server 350. In many embodiments, payment service server 360 also can send a notification 626 to wallet server 350 of the unlinking.

In many embodiments, the user can perform various consumer actions 633 through wallet server 350, such as through a wallet management website provided by wallet server 350. As an example of consumer actions 633, the user can initiate the unlinking of the account through wallet server 350. Once the unlinking has been initiated, wallet server 350 can notify payment service server 360 of the unlinking, after which payment service server 360 can perform activity 613 of purging data associated with the wallet of the user, and in many embodiments, payment service server 360 can notify wallet server 350 to confirm the unlinking and purge of the wallet data.

As another example of consumer actions 633, the user can add one or more new cards to the wallet of the user in wallet server 350. In addition, or alternatively, one or more new cards can be added to the wallet of the user by one or more issuers, such as through issuer updates 632. Upon one or more new cards being added to a wallet in wallet server 350, when the wallet is linked to a payment service account, and if the cards are eligible for linking, wallet server 350 can send a message 621 to payment service server 360 that one or more new cards have been added to the wallet. In many embodiments, message 621 can include card information, similar to card information 522 (FIG. 5).

In many embodiments, one or more cards can be deleted or otherwise removed from the wallet of the user in wallet server 350, such as through consumer actions 633 or issuer updates 632. In such cases, wallet server 350 can delete or otherwise remove the card in the wallet of the user in wallet server 350, and can send a message 622 to payment service server 360 that one or more cards are deleted or otherwise removed in the wallet. Upon receiving message 622, payment service server 360 can purge the information associated with the card that has been stored in payment service server 360. In some embodiments, individual cards linked into the payment service account cannot be deleted or otherwise removed by the user in payment service server 360. In other embodiments, the user can delete or otherwise remove individual payment cards in payment service server 360, which can result in purging the information associated with such cards and notifying wallet server 350 of the deletion and purge of such cards.

In many embodiments, wallet server 350 can receive updates to PII (personally identifiable information) of the user, such as the name, address, email address, phone number, date of birth, etc. In some cases, upon wallet server 350 receiving updates for certain types of PII that is eligible to be shared with payment service server 360, wallet server 350 can send a message 623 to payment service server 360 of the eligible PII updates.

In many embodiments, wallet server 350 can receive various card and/or token lifecycle events, which can be based on token service provider (TSP) updates 631 from token service provider 370 (FIG. 3) and/or issuer updates 632 from one or more issuers of the one or more cards. In some cases, upon wallet server 350 receiving such card and/or token lifecycle events, wallet server 350 can send a message 624 to payment service server 360 about the card and/or token lifecycle events. For example, if a token becomes suspended, payment service server 360 can suppress, delete, or otherwise withhold that card. If the card art changes, payment service server 360 can update the stored card art for display with the card. If a card expires or replaced, updated card information can be processed. If a token is deleted, it can be removed from payment service server 360. In some embodiments, if payment service server had previously suppressed a PAN-entered card in the payment service account of the user, and the token that is now deleted had replaced the PAN-entered card in the payment service account of the user, then payment service server 360 can un-suppress and display the PAN-entered card in the payment service account.

In many embodiments, wallet server 350 can receive various wallet state updates, which can be based on TSP updates 631 from token service provider 370 (FIG. 3), issuer updates 632 from one or more issuers of the one or more cards, consumer actions 633 from the user (e.g., 321 (FIG. 3), and/or based on other determination performed within wallet server 350. In some cases, upon wallet server 350 receiving such wallet state updates, wallet server 350 can send a message 625 to payment service server 360 about the wallet state updates. For example, if the wallet enters a temporary suspended state, the payment service server 360 will not display any cards from the linked wallet. If the wallet enters a restricted state, wallet server 350 can delete the cards in the wallet, and payment service server 360 can receive card deletion messages (e.g., 622). If the wallet enters a suspended or deleted state, the wallet can be unlinked from payment service server 360.

In many embodiments, payment service server 360 can perform an activity 611 of displaying one or more payment cards from the wallet, which can be displayed with the icon or other description associated with the wallet. In many embodiments, activity 611 can be similar to activity 524 (FIG. 5). In many embodiments, the updates made based on messages 621-625 can result in updates to the display of the cards linked from the wallet.

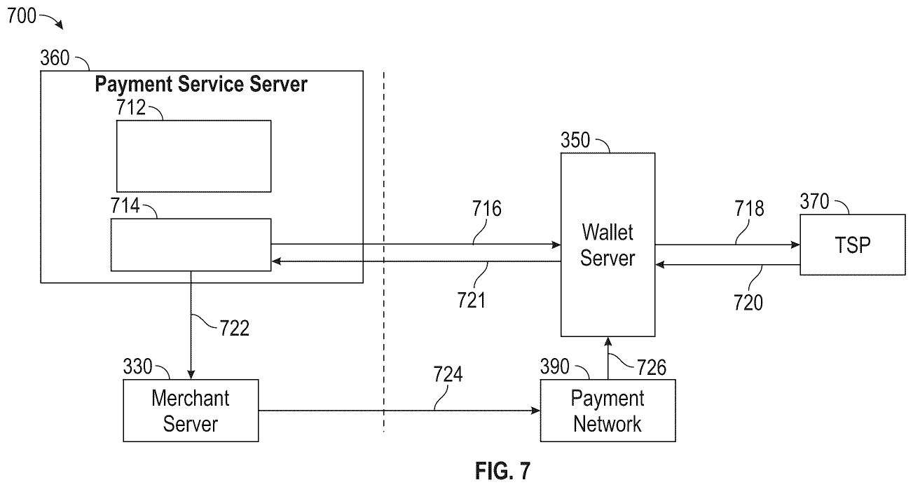

Turning ahead in the drawings, FIG. 7 illustrates a flow diagram of a data flow 700 between various system components (of system 300 (FIG. 3)) to initiate a purchase through the payment service provided by payment service server 360 based on a card that is linked from the wallet provided by wallet server 350. Data flow 700 is merely exemplary and is not limited to the embodiments presented herein. Data flow 700 can be employed in many different embodiments or examples not specifically depicted or described herein. In some embodiments, the procedures, the processes, and/or the activities of data flow 700 can be performed in the order presented. In other embodiments, the procedures, the processes, and/or the activities of data flow 700 can be performed in any suitable order. In still other embodiments, one or more of the procedures, the processes, and/or the activities of data flow 700 can be combined or skipped.

In many embodiments, system 300 and/or the components thereof can be suitable to perform data flow 700 and/or one or more of the operations, actions, and/or activities of data flow 700. In these or other embodiments, one or more of the operations, actions, and/or activities of data flow 700 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

In many embodiments, data flow 700 can include an activity 712 of payment service server 360 displaying one or more payment cards from the wallet, which can be displayed with the icon or other description associated with the wallet, in the payment service provided by payment service server 360, such as with the other cards that are in the payment service account of the user. In many embodiments, activity 712 can be similar to activity 524 (FIG. 5) and/or 611 (FIG. 6). In many embodiments, the cards can be displayed via an interface on user device 320 (FIG. 3)), such as through wallet app 322 (FIG. 3), a web-based interface, or another suitable interface.

In many embodiments, data flow 700 next can include an activity 714 of the user selecting to complete a transaction with the payment service using one of the cards linked from the wallet. In many embodiments, data flow 700 next can include an activity 716 of payment services server 360 requesting a payload from wallet server 350. In many embodiments, data flow 700 next can include an activity 718 of wallet server 350 requesting payload information from token service provider 370, followed by an activity 720 of token service provider 370 sending the requested payload information to wallet server 350, and an activity 721 of wallet server 350 sending the payload information to payment service server 360. In many embodiments, the payload information can include a token, a cryptogram associated with the token, a token expiry for the token, and/or other suitable information.

In a number of embodiments, data flow 700 next can include an activity 722 of payment service server 360 sending the payload information to merchant server 330 to process the transaction based on a card in the wallet. In many embodiments, the token and cryptogram can be used by merchants that are capable of processing network tokenization messages as defined by the EMVCo (Europay, Mastercard, and Visa Consortium) specifications. In a number of embodiments, payment service server 360 can filter out merchants who cannot process network tokens. In some embodiments, the token and cryptogram can be a dynamic payment authorization token. In some embodiments, the tokens and cryptograms provided by payment service server 360 for cards in the wallet provided by wallet server 350 can be the same type as those available to merchants who integrate directly with wallet server 350.

In many embodiments, data flow 700 next can include an activity 724 of merchant server 330 processing the transaction by sending the payment information to card network 390 and/or token service provider 370. In many embodiments, data flow 700 can include an activity 726 of card network 390 and/or token service provider 370 sending token notification events to wallet server 350, such as when the token has been used, been updated, has expired, etc.

In many embodiments, system 300 and/or the components thereof, such as payment service server 360 and wallet server 350, can be suitable to perform a data flow and/or one or more of the operations, actions, and/or activities similar to data flows 400, 500, 600, and 700 that enable interoperability between components of the system 300. In many embodiments, activities and/or financial transactions may occur between a user of the wallet and a merchant that reside in different countries. In one non-limiting example, the user of the wallet may reside or be otherwise located in the United States and a merchant the user wants to purchase something from resides in or is otherwise located outside of the United States. In such example, system 300 can facilitate a purchase through the payment service that enables the user located in the United States to utilize a card that is linked from the wallet to complete a purchase from the merchant that is located outside of the United States.

In another non-limiting example, the user of the wallet may reside or be otherwise located outside of the United States. In such example, system 300 can facilitate a purchase through the payment service that enables the user located outside of the utilize a card that is linked from the wallet to complete a purchase from the merchant that is located in of the United States.

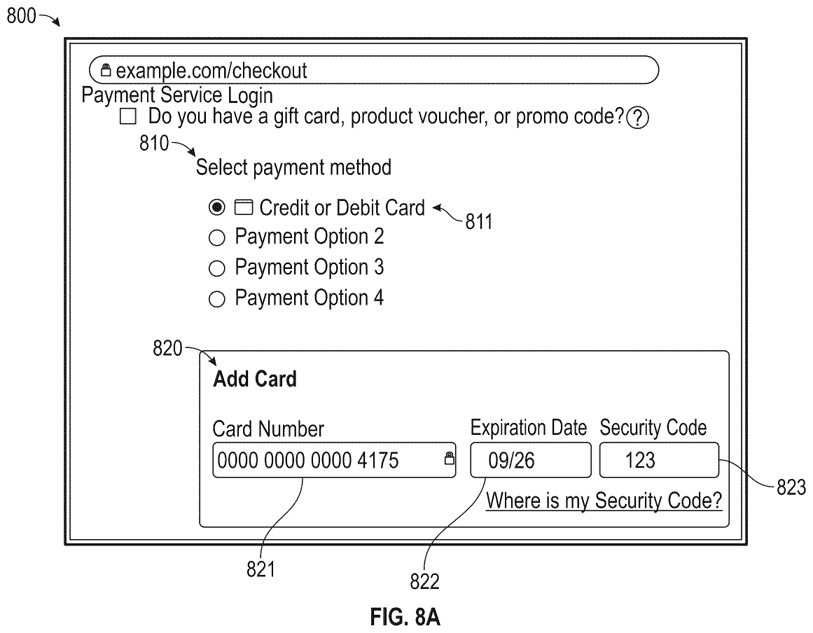

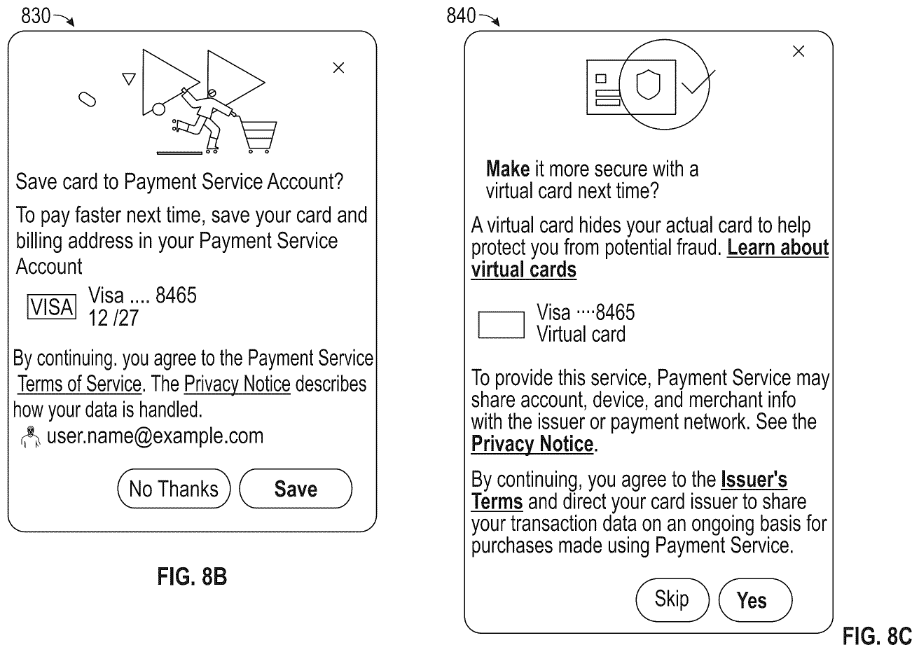

In many embodiments, payment service server 360 can prompt a user to activate and/or link the wallet of the user in wallet server 350 with the payment server account of the user in payment service server 360 in a variety of situations, including the process described in data flow 400 (FIG. 4) above, as well as others, including those described as follows in association with FIGS. 8A-C, 9A-B, and 10A-B.

For example, FIG. 8A illustrates an exemplary display screen 800 of a graphical user interface (GUI) of a website of a merchant displayed on a user device (e.g., 320 (FIG. 3)) used by a user (e.g., 321 (FIG. 3)) to initiate a checkout process that facilitates a purchase using a new card entered into a browser. Display screen 800 can be displayed when the user initiates an online transaction, such as by selecting a checkout button on a merchant webpage. In many embodiments, display screen 800 shows a payment portion of the checkout webpage provided by a merchant. Display screen 800 can include a payment selection prompt 810 to prompt the user to select a payment option or method. For example, the user can select a payment card option 811, upon which display screen 800 can display add card fields 820, such as a card number field 821, an expiration date field 822, and a verification value field 823.

FIG. 8B illustrates an exemplary prompt 830 that can be displayed on the browser to prompt the user to save a card to the payment service account of the user. For example, when the user enters the card information in add card fields 820 (FIG. 8A), prompt 830 can be displayed to ask the user whether to save the card in the payment service account of the user in payment service server 360 (FIG. 3). In many embodiments, this option can be presented when payment service server 360 (FIG. 3) and browser server 340 (FIG. 3) associated with the browser used by the user are operated by the same or affiliated entities.

In many embodiments, after the user enters card information in add card fields 820 (FIG. 8A), browser server 340 (FIG. 3) and/or payment service server 360 (FIG. 3) can send information to wallet server 350 (FIG. 3) to determine whether there is a wallet for the user that contains the card number. For example, the information sent to wallet server 350 (FIG. 3) can include the email address of the user, the last four digits of the card, the expiration number of the card, and/or other suitable information. If there is a wallet for the user, wallet server can return a success message to browser server 340 (FIG. 3) and/or payment service server 360 (FIG. 3), after which browser server 340 (FIG. 3) can cause the browser to display a prompt to the user to activate and/or link the wallet of the user to the payment service account of the user in payment service server 360 (FIG. 3). FIG. 8C illustrates an exemplary prompt 840 that can be displayed on the browser to prompt the user to convert the card entered to a virtual card. In some embodiments, the virtual card can mask or protect actual card information (e.g., card number, expiration date, verification value, etc.) of the card by generating unique card information that is linked to the card. As such, the unique card information can be used to complete a transaction in place of the actual card information. In some embodiments, by accepting prompt 840, the user can initiate the wallet linking experience, such as described above in data flow 400 (FIG. 4). In the same or other embodiments, the browser can display a prompt, such as prompt 2930 (FIG. 29), described below, which can prompt the user to learn more about the wallet service provided by wallet server 350 (FIG. 3) and/or select a button or other selectable button to initiate the linkage, such as described above in data flow 400 (FIG. 4). In many embodiments, using the wallet service can beneficially cause the cards associated with the user in the browser, as stored in browser server 340 (FIG. 3), to be virtual cards, to provide additional security.

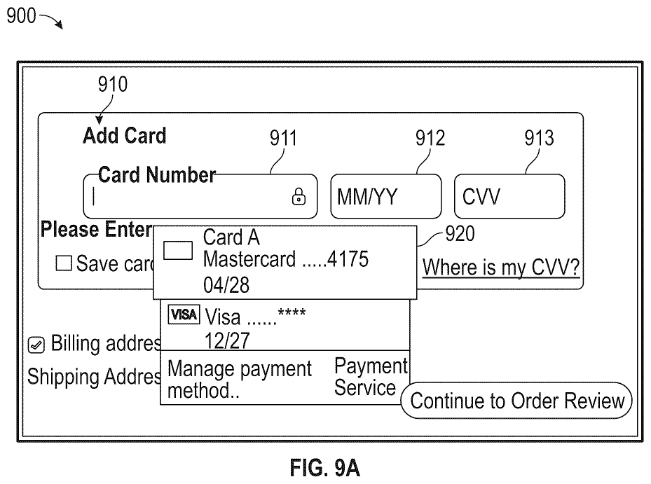

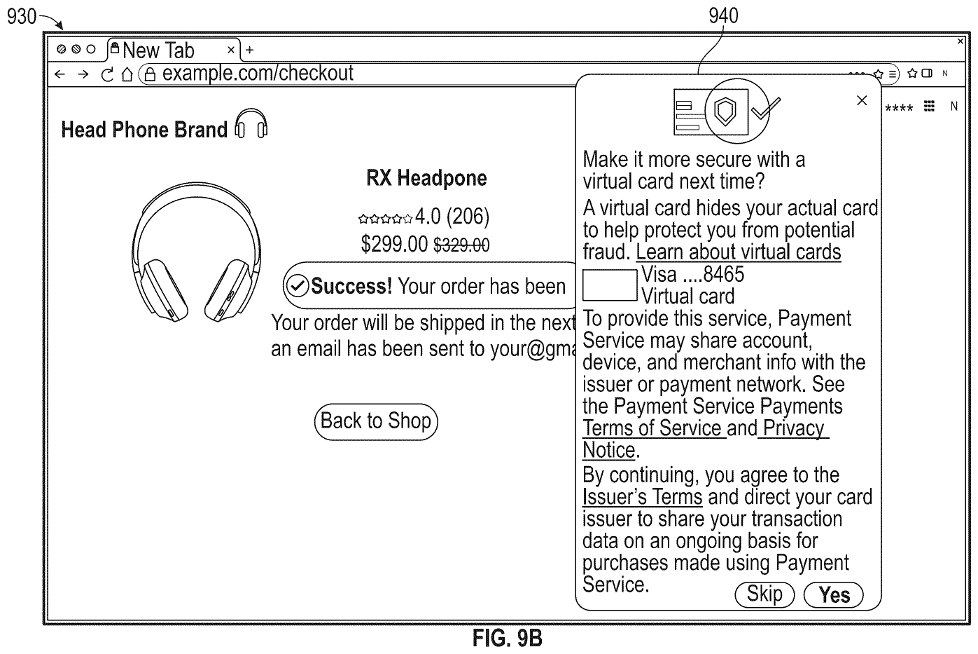

As another example, FIG. 9A illustrates an exemplary display screen 900 of a GUI of a website of a merchant displayed on a user device (e.g., 320 (FIG. 3)) used by a user (e.g., 321 (FIG. 3)) to initiate a checkout process that facilitates a purchase using a card already saved in a browser. Display screen 900 can be displayed when the user initiates a purchase, such as by selecting a checkout button on a merchant webpage. In many embodiments, display screen 900 shows a payment portion of the checkout webpage provided by a merchant. Display screen 900 can include add card fields 910, such as a card number field 911, an expiration date field 912, and a verification value field 913. When the user taps, clicks, or otherwise selects card number field 911, the cards saved in the browser can be displayed for autofill. For example, the user can select a card 920 that was saved in the browser for autofill.

In many embodiments, after the user selects card 920, browser server 340 (FIG. 3) and/or payment service server 360 (FIG. 3) associated with browser server 340 (FIG. 3) can send information to wallet server 350 (FIG. 3) to determine whether there is a wallet for the user that contains the card number. For example, the information sent to wallet server 350 (FIG. 3) can include the email address of the user, the last four digits of the card, the expiration number of the card, and/or other suitable information. If there is a wallet for the user, wallet server 350 (FIG. 3) can return a success message to browser server 340 (FIG. 3) and/or payment service server 360 (FIG. 3), after which browser server 340 (FIG. 3) can cause the browser to display a prompt to the user to activate and/or link the wallet of the user to the payment service account of the user in payment service server 360 (FIG. 3). FIG. 9B illustrates an exemplary display screen 930 of a GUI of the merchant after a successful transaction, including a prompt 940 displayed on the browser to prompt the user to convert the card entered to a virtual card. In some embodiments, by accepting prompt 940, the user can initiate the wallet linking experience, such as described above in data flow 400 (FIG. 4). In the same or other embodiments, the browser can display a prompt, such as prompt 2930 (FIG. 29), described below, which can prompt the user to learn more about the wallet service provided by wallet server 350 (FIG. 3) and/or select a button or other selectable button to initiate the linkage, such as described above in data flow 400 (FIG. 4). In many embodiments, using the wallet service can beneficially cause the cards associated with the user in the browser, as stored in browser server 340 (FIG. 3), to be virtual cards, to provide additional security.

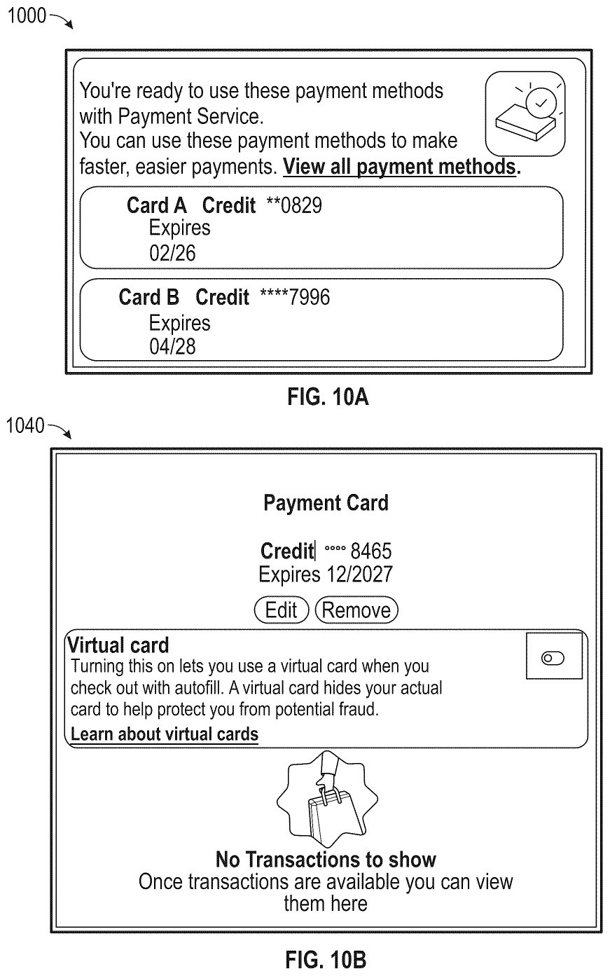

As another example, FIG. 10A illustrates an exemplary display screen 1000 of a GUI of a website provided by payment service server 360 (FIG. 3), which can be a payment service management website for the user to manage the payment service account of the user in payment service server 360 (FIG. 3). In some embodiments, when a user saves a card (e.g., through a PAN entry) to the payment service account, such as in the GUI shown in display screen 1000, payment service server 360 (FIG. 3) can prompt the user to optionally save the card as a virtual card, as shown in prompt 1040 of FIG. 10B. In some embodiments, by accepting prompt 1040, the user can initiate the wallet linking experience, such as described above in data flow 400 (FIG. 4). In the same or other embodiments, the browser can display a prompt, such as prompt 2930 (FIG. 29), described below, which can prompt the user to learn more about the wallet service provided by wallet server 350 (FIG. 3) and/or select a button or other selectable button to initiate the linkage, such as described above in data flow 400 (FIG. 4). In many embodiments, using the wallet service can beneficially cause the cards associated with the user in the browser, as stored in browser server 340 (FIG. 3), to be virtual cards, to provide additional security.

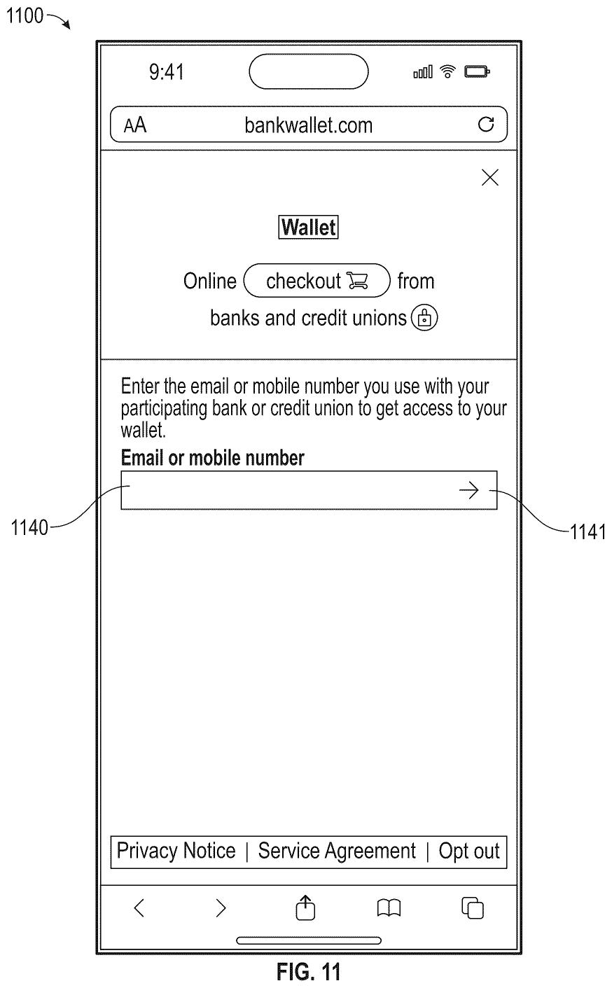

In many embodiments, the user can initiate linking the wallet to the payment service account through a wallet management website provided by wallet server 350 (FIG. 3). FIGS. 11-20 show a sequence of display screens for linking a wallet to a payment service account through a wallet management website provided by wallet server 350 (FIG. 3), such as displayed on user device 320 (FIG. 3)). Display screen 1100 shown in FIG. 11 is a welcome screen for the wallet service provided by wallet server 350 (FIG. 3). In many embodiments, display screen 1100 can be include a contact information field 1140, which can allow the user (e.g., 321 (FIG. 3)) to enter contact information, such as the email address, phone number, and/or other identifying information of the user to initiate logging into the wallet account for the user. Once entered, the user can select a continue button 1141 to proceed. For example, when the user enters a phone number or email address in contact information field 1140 and selects continue button 1141, wallet server 350 (FIG. 3) can determine whether the phone number or email address is associated with a wallet, and if so, can send an authentication code, such as an OTP, to the phone number associated with that account in order to authenticate the user. This authentication code can be used to prevent a user that is a fraudster from entering an email address or a phone number in contact information field 1140 for another individual and being able to continue to access the wallet account. In many embodiments, authentication can additionally and/or alternatively be performed using a passkey based on FIDO (Fast Identity Online) standards, multi-factor authentication, biometric authentication, and/or other suitable authentication methods.

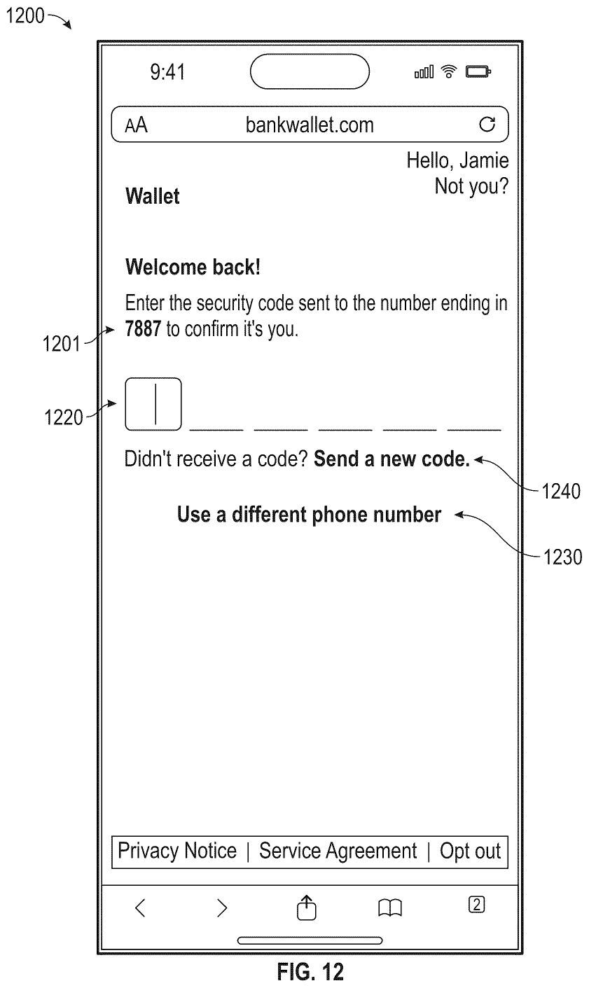

Display screen 1200 of FIG. 12 shows an example of a display screen that can be shown after the user selects continue button 1141 (FIG. 1). As shown in FIG. 12, display screen 1200 can include a phone number display field 1201, an authentication code field 1220, a change number selector 1230, and/or a new code send selector 1240. Phone number display field 1201 can include the phone number of the mobile phone of the user to which the authentication code was sent. In many embodiments, only a portion of the phone number is displayed in phone number display field 1201, such as the last four digits of the phone number. Authentication code field 1220 can be used by the user can enter the authentication code received in a text message. Change number selector 1230 can be selected by the user to use a different phone number, and/or to indicate that the phone number displayed in phone number display field 1201 is not the phone number associated with the user. In some embodiments, when change number selector 1230 is selected, the user can be prompted to enter a different phone number. If the new phone number entered is associated with the wallet, then the authentication code can be sent to that new phone number, similarly as described above. In other embodiments, such as when the user did not enter the phone number originally, but instead the phone number already associated with the wallet was used, an unrecognized number process can be performed to prevent a fraudster from using a phone number not associated with the wallet. New code send selector 1240 can be used to have a new authentication code sent to the phone number shown (at least partially) in phone number display field 1201. When new code send selector 1240 is selected, display screen 1200 can continue to be displayed to allow the user to enter the new authentication code in authentication code field 1220.

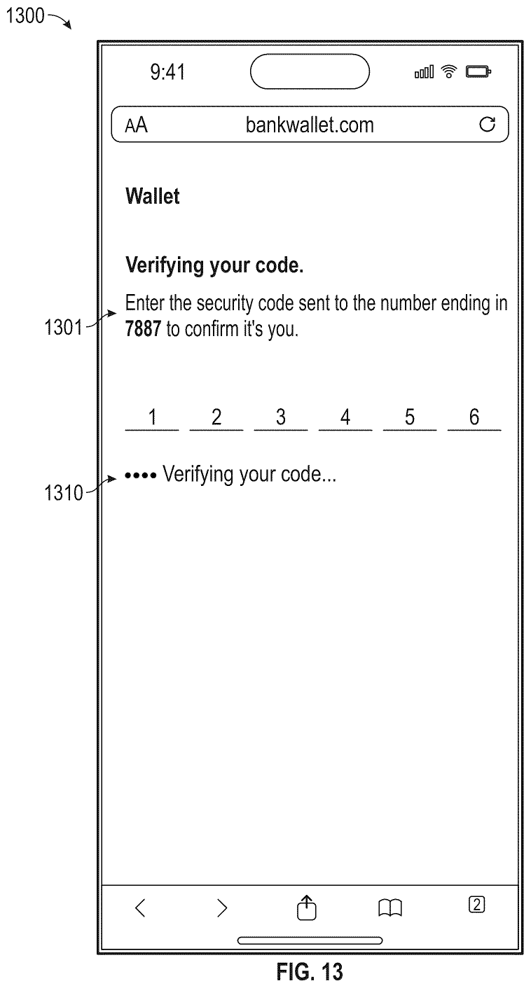

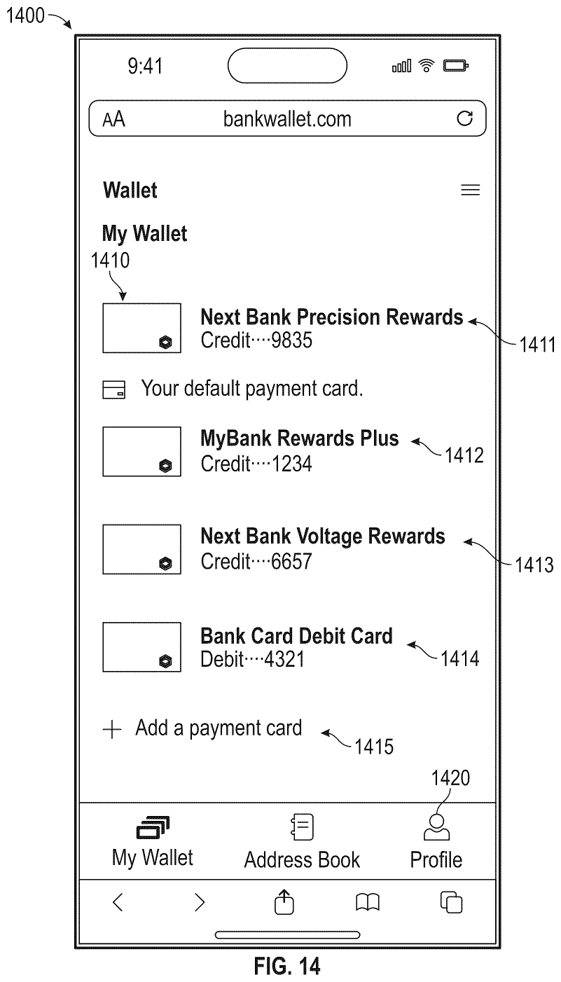

Once the authentication code is entered in authentication code field 1220, the user interface can update display screen 1200 to display screen 1300 shown in FIG. 13, which can include a processing descriptor 1301, which indicates that the code is being verified, and/or a processing indicator 1310, to indicate that the authentication code has been received, and further processing is occurring. Such further processing can include determining whether the authentication code entered in authentication code field 1220 (FIG. 12) matches the authentication code sent to the phone number. If the authentication code does not match, a method of handling an authentication failure can be used. In some cases, an enhanced authentication process can be used to require the user to enter additional authenticating information, such as entering the verification value (e.g., CVV, CVC) on one of the cards associated with the wallet of the user, which can occur at this point of the process, and/or can occur later. If the authentication process completes successfully, display screen 1400, as shown in FIG. 14 can be displayed.

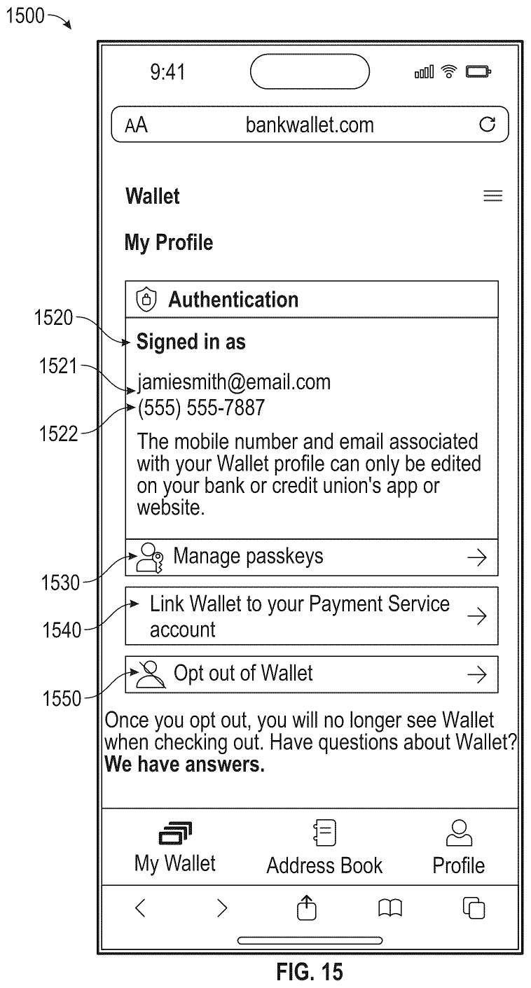

As shown in FIG. 14, display screen 1400 can be a “my wallet” page, which can include a card list 1410. Card list 1410 can include multiple cards, such as cards 1411-1414. Each of the cards listed can be a different card that is associated with the user in the wallet for the user in the wallet directory. These cards can all be issued by a single issuer (i.e., financial institution that issued the card) or various cards can be issued by various different issuers. For example, as shown in FIG. 14, there can be four cards issued by various banks. Card list 1410 can include, for each card, a card image and/or a card descriptor. The card descriptor can include a name of the issuer, the card name (which in some cases includes the name of the issuer), and/or other identifying information for the card, such as the last four digits of the card number. In some embodiments, the user can add a new payment card by using add card selector 1415. In some embodiments the user can switch to a “profile” page by selecting profile tab 1420 to display profile information for the wallet for the user, as shown in display screen 1500 of FIG. 15.

As shown in FIG. 15, display screen 1500 can be a “profile” page, which can include user information 1520, a manage passkeys button 1530, a link wallet to payment service account button 1540, and/or an opt out button 1550. User information 1520 can include an email field 1521, and/or a phone number field 1522. Email field 1521 can show the email address registered in the wallet associated with the user in the wallet directory. Phone number field 1522 can show the phone number registered in the wallet associated with the user in the wallet directory. In many embodiments, it will be understood that user information can include other suitable information in addition or alternative to the email address or phone number of the user. Manage passkeys button 1530 can be selected by the user to update passkeys associated with the wallet for the user. Link wallet to payment service account button 1540 can be selected by the user to initiate linking the wallet of the user to the payment service account for the user. Opt out button 1550 can be selected by the user to opt out of using the wallet service and deleting the wallet associated with the user. In many embodiments, when link wallet to payment service account button 1540 is selected, display screen 1600 of FIG. 16 can be displayed to the user.

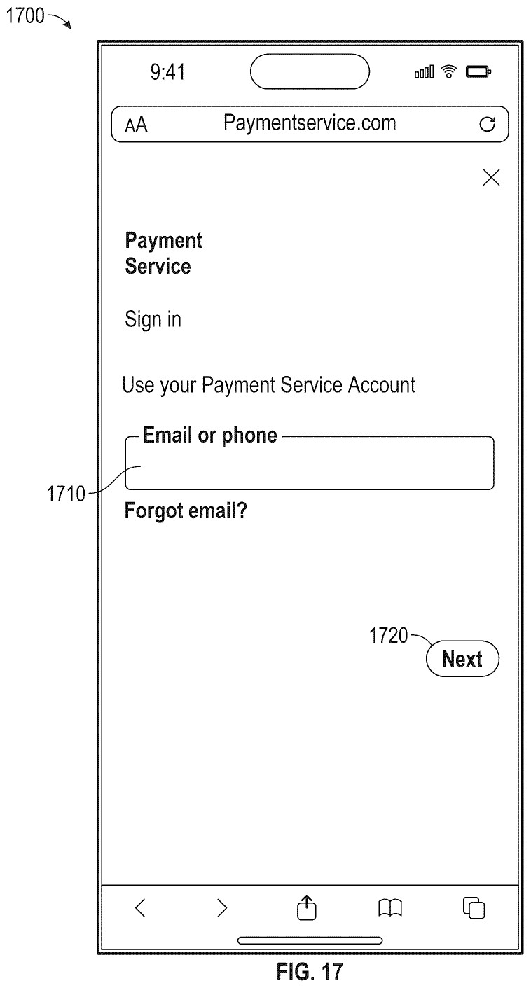

As shown in FIG. 16, display screen 1600 can display information 1610 about linking the wallet to the payment service account, and can include a cancel button 1620 to allow the user to decline, and a continue button 1630 to allow the user to proceed with linking the accounts. In many embodiments, when the user selects continue button 1630, wallet server 350 (FIG. 3) can call payment service server 360 (FIG. 3), and payment service server 360 can ask the user to log into the payment service account for the user, as shown in display screen 1700 of FIG. 17.

As shown in FIG. 17, display screen 1700 can prompt the user to sign in to the payment service account of the user. Display screen 1700 can include a user information input field 1710, in which the user can enter the email address, phone number, and/or other identifying information of the user, and a continue button 1720, after which the user can be prompted to enter the password of the user (not shown). After the user successfully logs into the payment service account, payment service server 360 (FIG. 3) can return control to wallet server 350 (FIG. 3), after which display screen 1800 of FIG. 18 can be displayed to the user. In many embodiments, display screen 1700 can include a forgot user information button (not labeled) selectable by the user if the user forgot the email address, phone number, or other identifying information used for input into user information input field 1710.

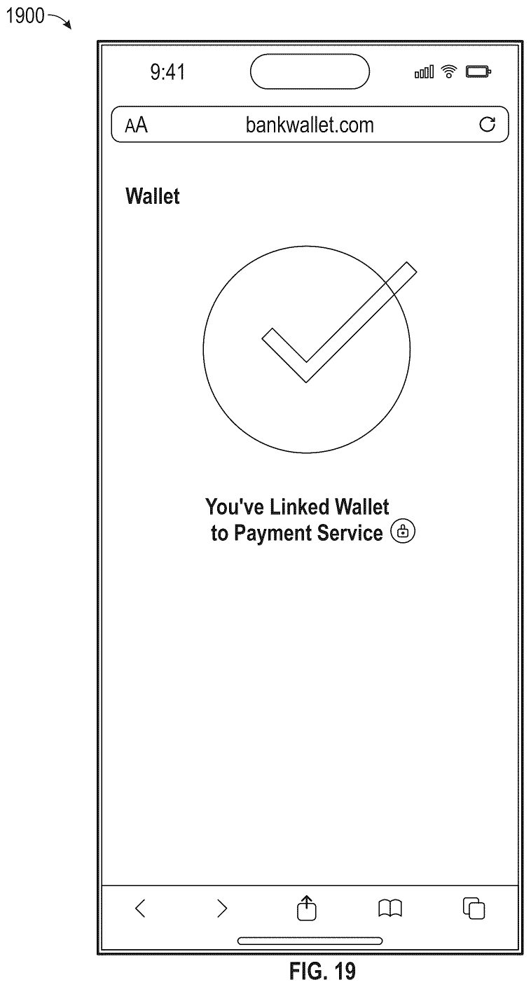

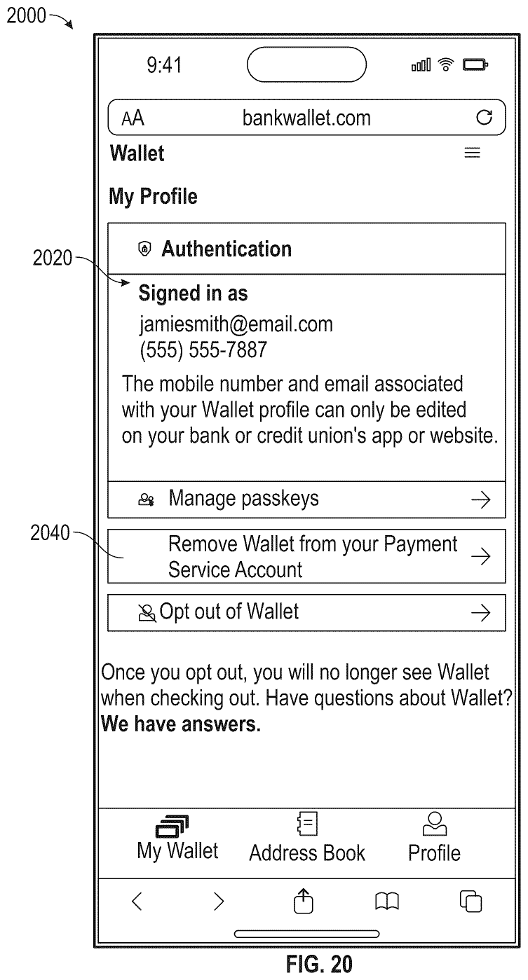

As shown in FIG. 18, display screen 1800 can include a link wallet information field 1810 that displays information to the user about linking the wallet, and can provide a URL (uniform resource locator) which the user can select to manage the payment cards or unlink the wallet. In many embodiments, display screen 1800 can include a card list 1820, which can list the payment cards in the wallet that are eligible to the linked to the payment service account. In some embodiments, trust settings from the issuer of the payment card can affect whether a payment card is eligible to be linked to a payment service account. Display screen 1800 also can include a cancel button 1830, by which the user can cancel the linking, and a proceed button 1840, by which the user can proceed with linking the wallet of the user to the payment service account of the user. Once the wallet is successfully linked, display screen 1900 of FIG. 19 can be displayed, which confirms that the linking was successful. When the user returns to the “profile” page, it can be updated, as shown in display screen 2000 of FIG. 20.

As shown in FIG. 20, display screen 2000 can be similar to display screen 1500 of FIG. 15, such as including user information 2020, which can be similar or identical to user information 1520 (FIG. 15). However, link wallet to payment service account button 1540 of FIG. 15 can be updated on display screen 2000 of FIG. 20 to include a remove wallet from payment service account button 2040, as the wallet is now linked to the payment service account.

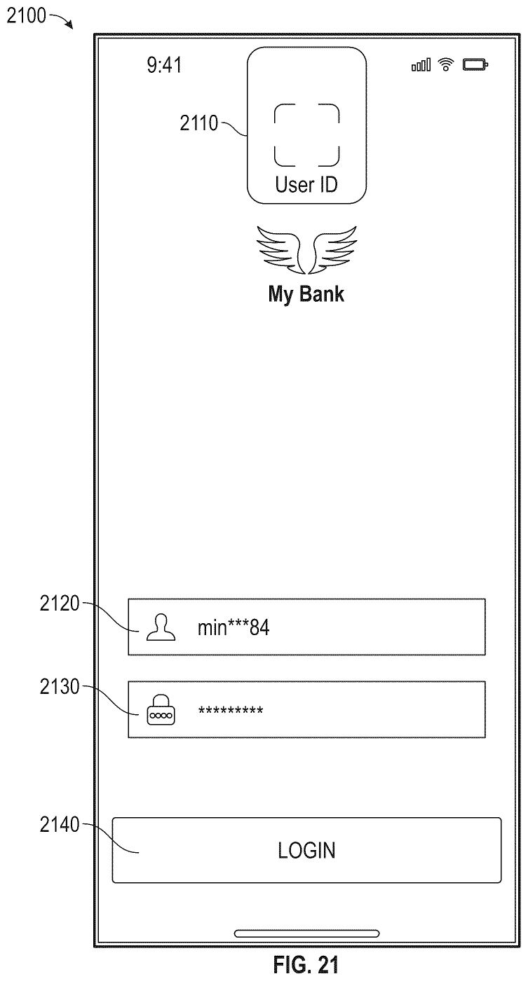

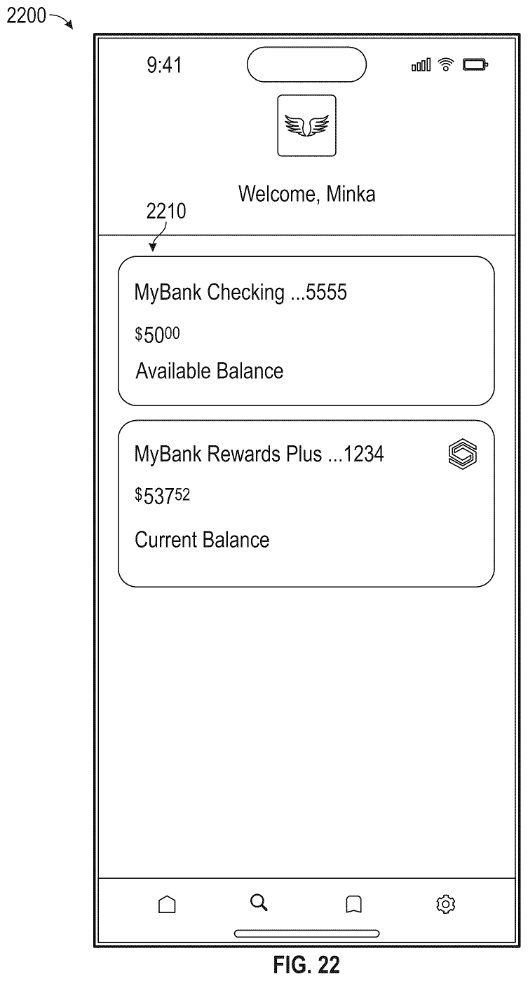

In many embodiments, the user can initiate linking the wallet to the payment service account through a bank app or bank website. FIGS. 21-24, FIGS. 16-19, and FIG. 25 show a sequence of display screens for linking the wallet to the payment service account when starting at a bank interface, such as a bank app or bank website provided by an issuer. Display screen 2100 shown in FIG. 21 is a login screen for the bank app. Display screen 2100 can include a login input field 2120, a password input field 2130, and/or a login button 2140, which can be used by the user to input the login credentials and proceed. In addition, or alternatively, the bank app can use biometric recognition, such as facial recognition, fingerprint scan, iris scan, etc., which processing can be indicated by a user ID indicator 2110. Once the user is logged in to the bank app, display screen 2200 of FIG. 22 can be displayed.

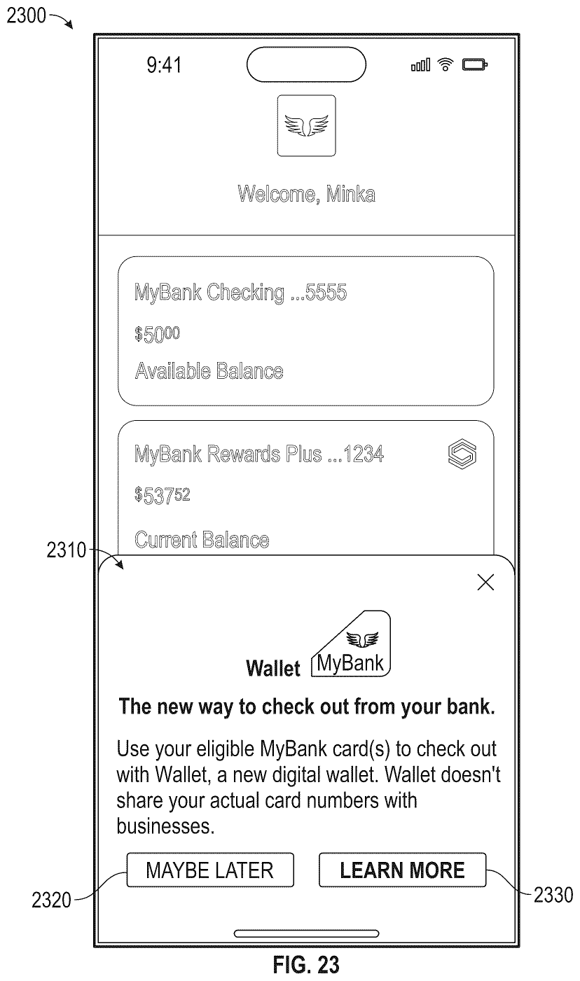

As shown in FIG. 22, display screen 2200 can be a home screen for the bank app, which can include an account list 2210. In some embodiments, once user is logged in, or at another point in using the bank app, if the user has not yet activated the wallet for the user in wallet server 350 (FIG. 3), a prompt can be displayed to the user to inform the user about the wallet service provide by wallet server 350 (FIG. 3). For example, as shown in FIG. 23, display screen 2300 can include a prompt 2310, which can display information about the wallet service. Prompt 2310 can include a cancel button 2320, by which the user can decline, and a proceed button 2330, by which the user can proceed to the wallet service.

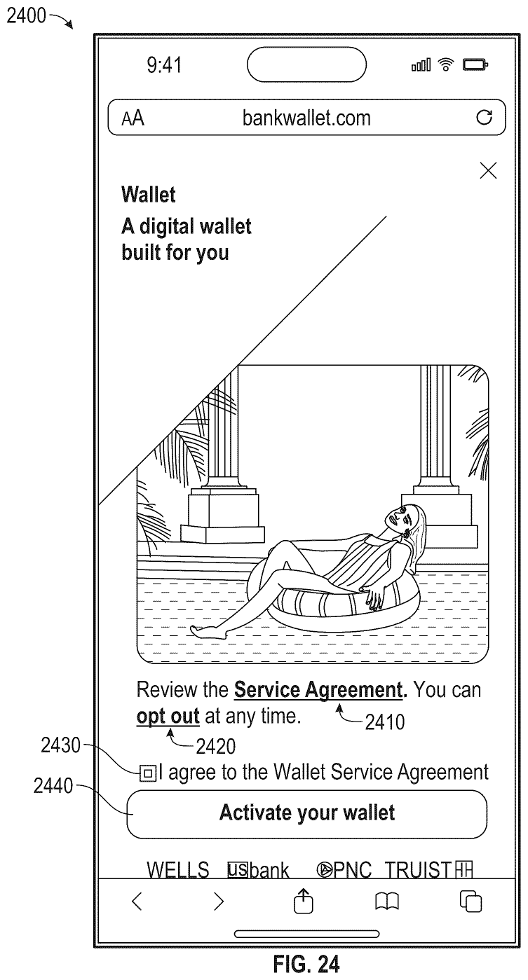

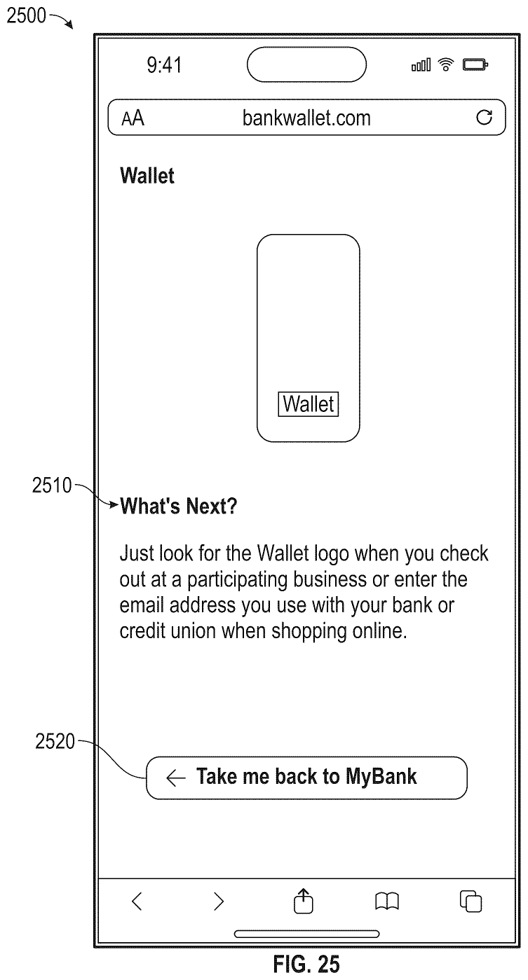

As shown in FIG. 24, display screen 2400 can be a welcome screen for the wallet service provided by wallet server 350 (FIG. 3). Display screen 2400 can include a link 2410 to a service agreement for the wallet service, a link 2420 to opt out of the wallet service, an agreement selector 2430, and an activation button 2440. Once the user has reviewed the service agreement and agreed selected agreement selector 2430, activation button 2440 can be enabled, to allow the user to activate the wallet. In many embodiments, once the wallet is activated, wallet service can present the option to link the wallet to the payment service account provided by payment service server 360 (FIG. 3). The processing of this linkage can be similar or identical as shown in FIGS. 16-19, and described above. Once the wallet is successfully linked, after display screen 1900 of FIG. 19 is displayed, a display screen 2500 of FIG. 25 can be displayed. As shown in FIG. 25, display screen 2500 can include additional information 2510 about the wallet service, and a button 2520 to allow the user to return to the bank app.

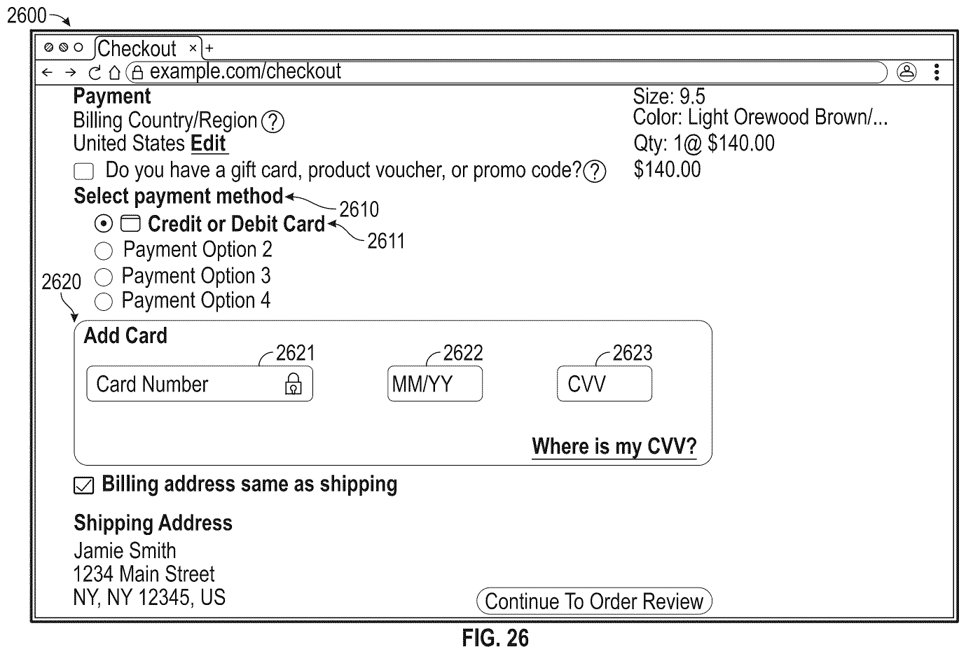

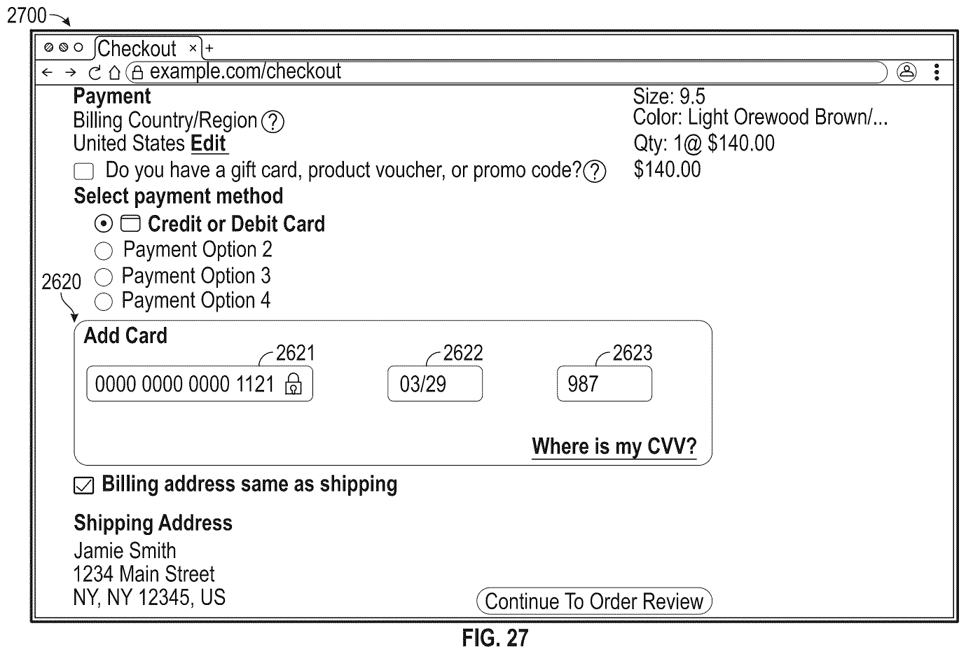

In many embodiments, the user can initiate linking the wallet to the payment service account through a browser of a merchant. FIGS. 26-31 show a sequence of display screens for linking the wallet to the payment service account when starting at a merchant checkout when no cards are saved in the browser. FIG. 26 illustrates a display screen 2600 that can be displayed when the user initiates a checkout process that facilitates a purchase, such as by selecting a checkout button on a merchant webpage. In many embodiments, display screen 2600 shows a payment portion of the checkout webpage provided by a merchant (e.g., associated with merchant server 330 (FIG. 3)). Display screen 2600 can include a payment selection prompt 2610 to prompt the user to select a payment option or method. For example, the user can select a payment card option 2611, upon which display screen 2600 can display add card fields 2620, such as a card number field 2621, an expiration date field 2622, and a verification value field 2623. When no cards have been saved in the browser, when user taps or selects card number field 2621, the user can enter a new card, such as shown in display screen 2700 of FIG. 27. As shown in display screen 2700, which is an update of display screen 2600, information for a new card can be entered into add card fields 2620. The payment information entered in add card fields 2620 can be sent to merchant server 330 (FIG. 3).

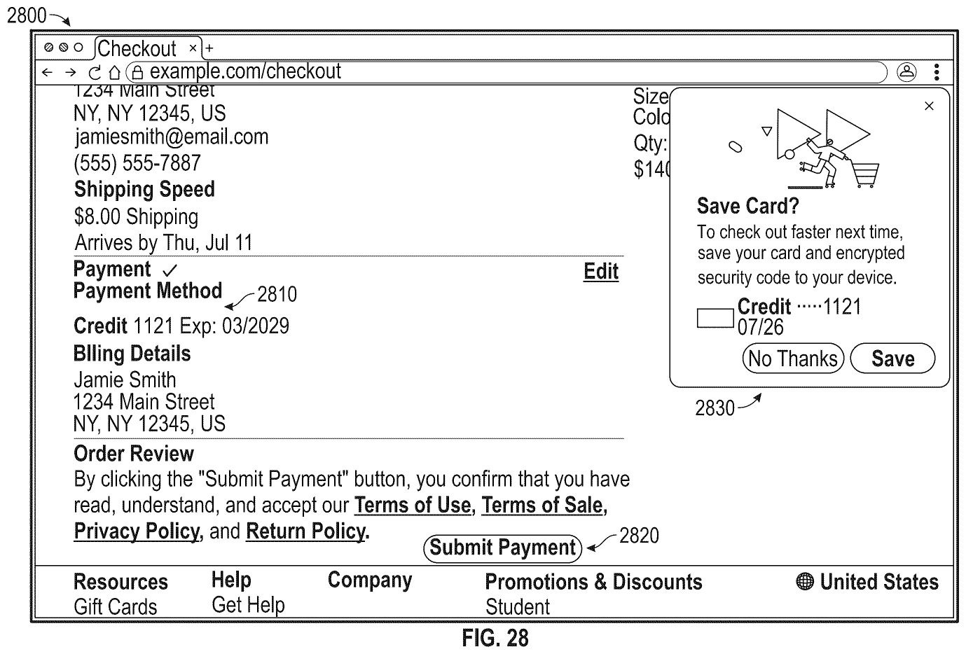

For example, FIG. 28 illustrates an exemplary display screen 2800 that is an update of display screen 2700, showing the payment information having been received by the merchant. As shown in FIG. 28, display screen 2800 includes payment information 2810, which includes a portion of the card number and the expiration date. With the payment method confirmed, the user can then select a submit payment button 2820 to process the payment using the payment method. In many embodiments, display screen 2800 can include a prompt 2830 that can be displayed on the browser to prompt the user to save the newly entered card to the browser of the user for use during future transactions. In many embodiments, browser server 340 (FIG. 3) can save the payment card for browser autofill.

When browser server 340 (FIG. 3) and payment service server 360 (FIG. 3) are operated by the same or affiliated entities, browser server 340 and/or payment service server 360 FIG. 3) can send information to wallet server 350 (FIG. 3) to determine whether there is a wallet for the user that contains the card number. For example, the information sent to wallet server 350 (FIG. 3) can include the email address of the user, the last four digits of the card, the expiration number of the card, and/or other suitable information. If there is a wallet for the user, wallet server can return a success message to browser server 340 (FIG. 3) and/or payment service server 360 (FIG. 3), after which browser server 340 (FIG. 3) can cause the browser to display a prompt to the user to link the wallet of the user to the payment service account of the user in payment service server 360 (FIG. 3).

FIG. 29 illustrates a display screen 2900 that is an update of display screen 2800 (FIG. 28), which includes an exemplary prompt 2930 that can be displayed on the browser to prompt the user to link the wallet of the user to the payment service account of the user, which can allow the cards in the wallet to be used in the payment service, and also allow the cards to be saved in the browser and/or browser server 340 (FIG. 3). In many embodiments, the cards linked from the wallet can be stored as virtual cards, to provide additional security. In many embodiments, prompt 2930 can include a cancel button 2931, by which the user can decline linking the account, and a proceed button 2932, which can initiate linking the account. In many embodiments, when the user selects proceed button 2932, an OTP SMS, passkey based on FIDO standards, multi-factor authentication activity, biometric authentication activity, and/or other suitable authentication activity can be sent to the user to authenticate the user.

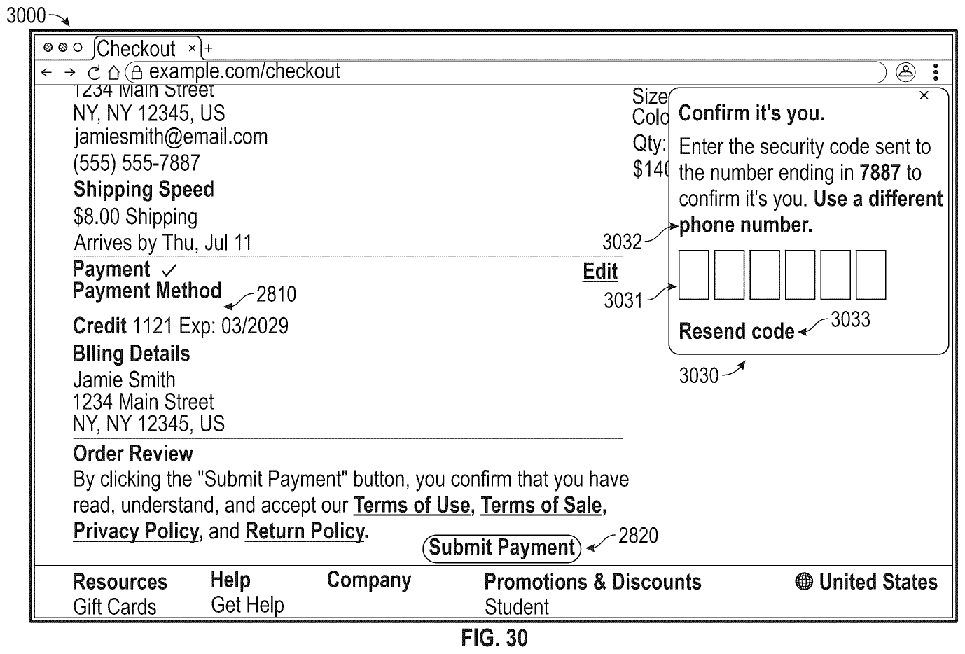

FIG. 30 illustrates a display screen 3000 that is an update of display screen 2900 (FIG. 29), which includes a verification code prompt 3030 that asks the user to enter the code (e.g., OTP, passkey, or other suitable authentication information) sent to the mobile phone of the user in an input field 3031. Alternatively, the user can select a link 3032 to request using a different phone number, or select a link 3033 to request resending the code to the mobile phone. Once the user enters the code in input field 3031, the code can be verified, and is correct, the wallet of the user in wallet server 350 (FIG. 3) can be linked to the payment service account of the user in payment service server 360 (FIG. 3), and in some embodiments, the payments cards in the wallet can be stored in browser server 340 (FIG. 3) to be used in the checkout process at merchants through the browser.

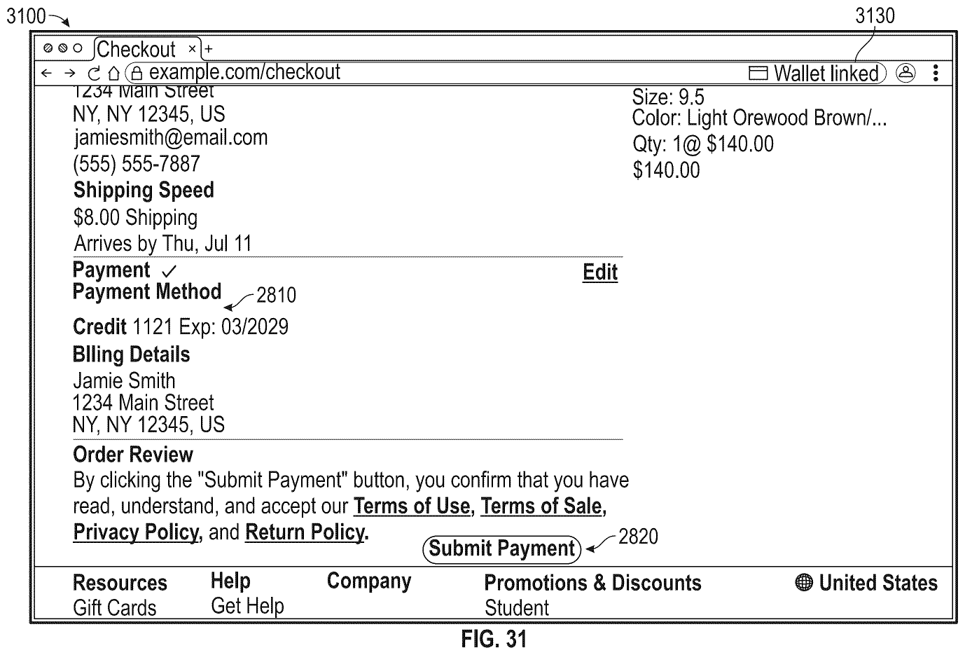

FIG. 31 illustrates a display screen 3100 that is an update of display screen 3000 (FIG. 30), which includes a notification 3130 that the linkage of the wallet of the user in wallet server 350 (FIG. 3) to the payment service account of the user in payment service server 360 (FIG. 3) is successful.

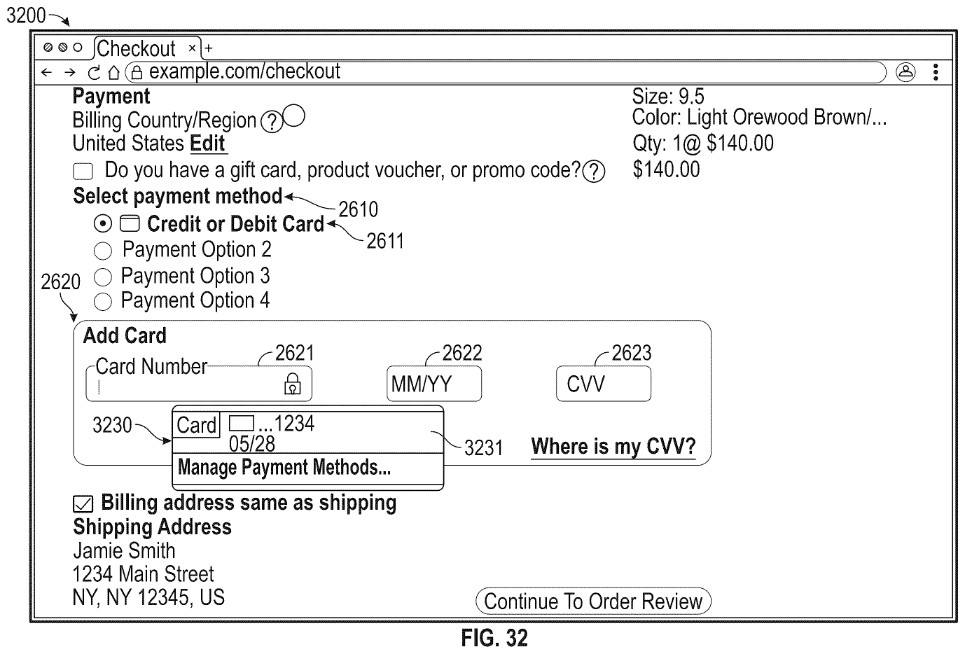

FIGS. 32, 29-30, 33, and 31 show a variance of the previous sequence, with a sequence of display screens for linking the wallet to the payment service account when starting at a merchant checkout when cards are already saved in the browser. FIG. 32 illustrates a display screen 3200 that can be displayed when the user initiates a checkout process that facilitates a purchase, such as by selecting a checkout button on a merchant webpage. In many embodiments, display screen 3200 shows a payment portion of the checkout webpage provided by a merchant (e.g., associated with merchant server 330 (FIG. 3)). Display screen 3200 can be similar to display screen 2600 (FIG. 26), and can include payment selection prompt 2610 to prompt the user to select a payment option or method. For example, the user can select payment card option 2611, upon which display screen 3200 can display add card fields 2620, such as card number field 2621, expiration date field 2622, and verification value field 2623. In many embodiments, when the user clicks on, taps in, or otherwise selects card number field 2621, a payment instruments autofill pop-up 3230 can be displayed on display screen 3200. Payment instruments autofill pop-up 3230 can include various payment instruments that have been saved by the user in the browser. For example, as shown in FIG. 32, payment instruments autofill pop-up 3230 can include a card list with one or more cards. The card list can include, for each card, a card image and/or a card descriptor. The card descriptor can include a name of the issuer, the card name (which in some cases includes the name of the issuer), and/or other identifying information for the card, such as the last four digits of the card number. The user can select the desired card in the card list, such as card 3231.

Once card (e.g., 3231) has been selected, the payment information can be sent to the merchant. At this point, browser server 340 and/or payment service server 360 (FIG. 3) can send information to wallet server 350 (FIG. 3) to determine whether there is a wallet for the user that contains the card number. For example, the information sent to wallet server 350 (FIG. 3) can include the email address of the user, the last four digits of the card, the expiration number of the card, and/or other suitable information. If there is a wallet for the user, wallet server can return a success message to browser server 340 (FIG. 3) and/or payment service server 360 (FIG. 3), after which browser server 340 (FIG. 3) can cause the browser to display a prompt to the user to link the wallet of the user to the payment service account of the user in payment service server 360 (FIG. 3). The prompt can be similar or identical to prompt 2930 shown in display screen 2900 of FIG. 29. As described above in connection with FIG. 29, if the user seeks to proceed with linking the account, the user can be sent an OTP SMS, passkey based on FIDO standards, multi-factor authentication activity, biometric authentication activity, and/or other suitable authentication activity. Next, a verification code prompt can be displayed to the user to enter the OTP or other suitable authentication information. The verification code prompt can be similar or identical to verification code prompt 3030 of display screen 3000 (FIG. 30). Once the user enters the code in the verification code prompt, in some embodiments, a linking information prompt can be display to the user.

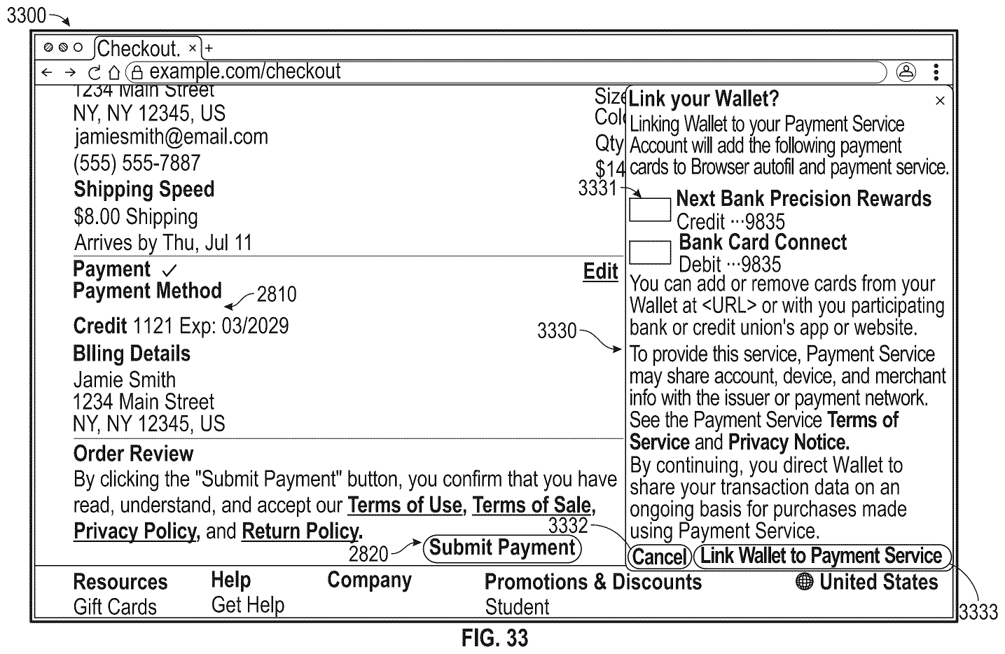

FIG. 33 illustrates a display screen 3300 that is an update of display screen 3000 (FIG. 30), which includes a prompt 3330 to confirm the cards in the wallet to be linked to the payment service account. For example, prompt 3330 can include a card list 3331, which can list the payment cards in the wallet that are eligible to the linked to the payment service account. In some embodiments, trust settings from the issuer of the payment card can affect whether a payment card is eligible to be linked to a payment service account. Prompt 3330 also can include a cancel button 3332, by which the user can cancel the linking, and a proceed button 3333, by which the user can proceed with linking the wallet of the user to the payment service account of the user. Once the wallet of the user in wallet server 350 (FIG. 3) is successfully linked to the payment service account of the user in payment service server 360 (FIG. 3), a notification can be displayed of the successful linkage, such as notification 3130 of display screen 3100 of FIG. 31.

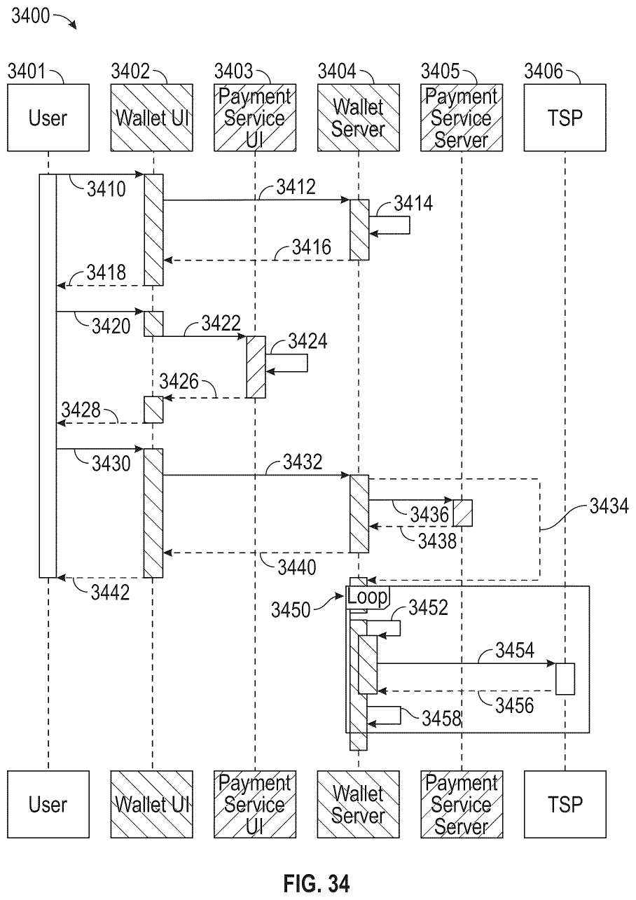

Turning ahead in the drawings, FIG. 34 illustrates a sequence diagram of a method 3400 of linking a wallet to a payment service account through a wallet management user interface provided by a wallet server, such as displayed on user device 320 (FIG. 3). Method 3400 is merely exemplary and is not limited to the embodiments presented herein. Method 3400 can be employed in many different embodiments or examples not specifically depicted or described herein. In some embodiments, the procedures, the processes, and/or the activities of method 3400 can be performed in the order presented. In other embodiments, the procedures, the processes, and/or the activities of method 3400 can be performed in any suitable order. In still other embodiments, one or more of the procedures, the processes, and/or the activities of method 3400 can be combined or skipped.

In many embodiments, system 300 and/or the components thereof can be suitable to perform method 3400 and/or one or more of the operations, actions, and/or activities of method 3400. In these or other embodiments, one or more of the operations, actions, and/or activities of method 3400 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

Referring to FIG. 34, in many embodiments, method 3400 can involve various activities and/or interactions, such as messages, calls, or responses, between various systems and/or components, such as a user 3401, a wallet user interface (UI) 3402, a payment service user interface 3403, a wallet server 3404, a payment service server 3405, and/or a token service provider 3406. User 3401 can be similar or identical to user 321 (FIG. 3) and/or user device 320 (FIG. 3). Wallet user interface 3402 can be similar or identical to the user interface that generates the display screens shown in FIGS. 11-16, 18-20, and 24-25. Payment service user interface 3403 can be similar or identical to the user interface that generates the display screens shown in FIGS. 10A and/or 17. Wallet server 3404 can be similar or identical to wallet server 350 (FIG. 3). Payment service server 3405 can be similar or identical to payment services server 360 (FIG. 3). Token service provider 3406 can be similar or identical to token service provider 370 (FIG. 3).

In many embodiments, method 3400 can begin with user 3401 performing an activity 3410 of logging into wallet user interface 3402 (e.g., as shown in FIG. 11-13) or otherwise navigating to wallet user interface 3402, such as from an issuer user interface (e.g., as shown in FIGS. 23-24). Method 3400 can next include wallet user interface 3402 making a call 3412 to wallet server 3404 to determine if the wallet of the user in wallet server 3404 can link to a payment service account in payment service server 3405. Method 3400 can next include an activity 3414 of wallet server 3404 determining if the wallet of the user can link to a payment service account in payment service server 3504. In some embodiments, activity 3414 can be performed by wallet server 3404 determining whether an email address, phone number, or other identifying information for the user in the wallet of the user is an email address, phone number, and/or other identifying information associated with payment service server 3405. For example, this determination can be made by determining if the domain name of the email address is associated with payment service server 3405 or an affiliate thereof, or by querying payment service server 3405 to ask if the email address is associated with a payment service account in payment service server 3405. Method 3400 can next include wallet server 3404 returning a result 3416 to wallet user interface 3402, which if the answer is yes, can result in wallet user interface 3402 performing an activity 3418 of displaying to user 3401 an option to link the wallet to the payment service. For example, activity 3418 can be similar or identical to displaying payment service account button 1540 (FIG. 15) and/or display screen 1600 (FIG. 16).

In many embodiments, method 3400 can next include user 3401 performing an activity 3420 of tapping (or otherwise selecting) the option displayed on wallet user interface 3402 to link the wallet to the payment service. Method 3400 can next include wallet user interface 3402 performing an activity 3422 of redirecting the user device of the user to payment service user interface 3403, for payment service user interface 3403 to display a login screen for the user to log into payment service server 3405. In many embodiments, the redirect can be a pop-up or a separate web page or other interface provided by payment service user interface 3403. Method 3400 can next include an activity 3424 of payment service user interface 3403 displaying the login screen for the user to log into payment service server 3405. For example, the login screen displayed in activity 3422 can be similar or identical to display screen 1700 (FIG. 17). In some embodiments, activity 3424 also can include authenticating the user, such as through an OTP, passkey based on FIDO standards, multi-factor authentication activity, biometric authentication activity, and/or other suitable techniques. In many embodiments, activity 3424 can include payment service user interface 3403 displaying terms and conditions and/or a service agreement for linking the wallet to the payment service account. Method 3400 can next include payment service user interface 3403 performing an activity 3426 of redirecting the user device back to wallet user interface 3402, which in many embodiments can include payment service user interface 3403 (of payment service server 3405) sending a link ID for the payment service account of the user to wallet user interface 3402 (or wallet server 3404). Method 3400 can next include wallet user interface 3402 performing an activity 3428 of displaying to the user a linking confirmation screen. In some embodiments, the linking confirmation screen can include terms and conditions and/or a service agreement for linking the wallet to the payment service account, and/or can include an option to confirm and proceed with the linking. The linking confirmation screen can be similar or identical to display screen 1800 (FIG. 18).

In many embodiments, method 3400 can next include user 3401 performing an activity 3430 of tapping (or otherwise selecting) an option displayed on wallet user interface 3402 to confirm linking the wallet to the payment service. The option to confirm the linking can be similar or identical to proceed button 1840 (FIG. 18). Method 3400 can next include wallet user interface 3402 making a call 3432 to wallet server 3404 to link the wallet of the user to the payment service account of the user. In many embodiments, call 3432 can include the link ID for the payment service account of the user. In some embodiments, wallet server 3404 optionally can perform an activity 3434 of initiating an asynchronous process 3450 to get and store autofill tokens for the cards in the wallet of the user for subsequent use in autofill checkout at merchant websites displayed in the browser of the user, as described below in further detail. In many embodiments, wallet server 3404 can next make a call 3436 to payment service server 3405 to add cards from the wallet of the user in wallet server 3404 to the payment service account of the user in payment service server 3405. In many embodiments, call 3436 can include the link ID for the payment service account and card information for each payment card in the wallet of the user in wallet server 3404. In many embodiments, the card information can include, for each payment card, a wallet card ID, a portion of the PAN (e.g., the last four digits of the PAN), the expiration date, the PAR (payment account reference), card art URI (uniform resource identifier), card product name, and/or other suitable information. In many embodiments, payment service server 3405 can store this information in the payment service account for the user for linking the payment cards from the wallet of the user in wallet server 3404 into the payment service account of the user in payment service server 3405. Method 3400 can next include payment service server 3405 providing a response 3438 to wallet server 3404, after which wallet server 3404 can provide a response 3440 to wallet user interface 3402, after which wallet user interface 3402 can perform an action 3442 of displaying a subsequent screen to user 3401. In many embodiments, if the linking action was successful, the subsequent screen displayed to the user can be a success screen, which can be similar or identical to display screen 1900 (FIG. 19).

Process 3450 to get and store autofill tokens for the cards in the wallet of the user for subsequent use in autofill checkout at merchant websites displayed in the browser of the user can be performed as a loop for each card in the wallet of the user in wallet server 3404. In many embodiments, process 3450 can include an activity 3452 of wallet server 3404 determining whether an autofill token is not already available for the card. If not, wallet server 3404 can make a call 3454 to token service provider 3406 to provision an autofill token for the card. Next, token service provider 3406 can provide a response 3456 to wallet server 3404, which can include information for the token, such as a token unique reference (TUR) and/or other suitable information. In many embodiments, process 3450 can next include an activity 3458 of wallet server 3404 updating the card, such as updating the information about the token available for autofill checkout using the card.

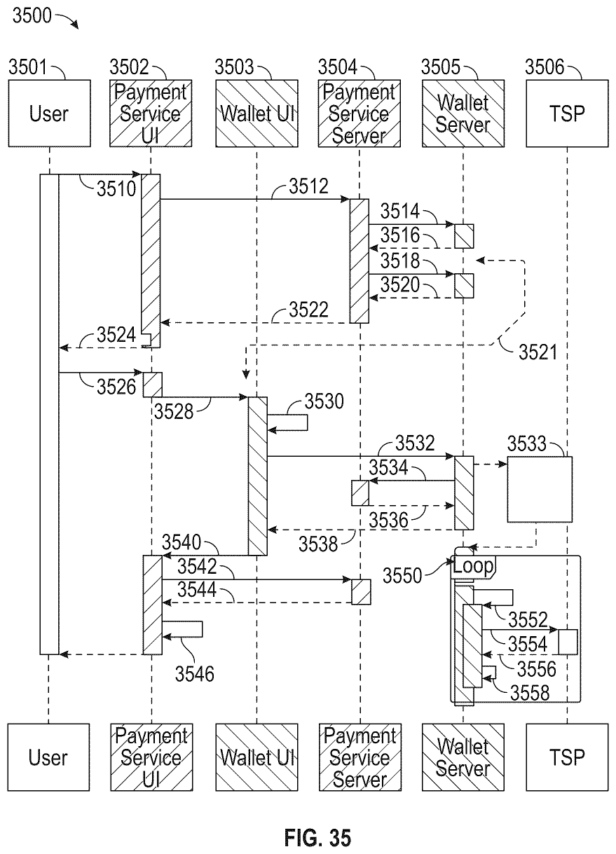

Turning ahead in the drawings, FIG. 35 illustrates a sequence diagram of a method 3500 of linking a wallet to a payment service account through a payment service user interface provided by a payment service server, such as displayed on user device 320 (FIG. 3). Method 3500 is merely exemplary and is not limited to the embodiments presented herein. Method 3500 can be employed in many different embodiments or examples not specifically depicted or described herein. In some embodiments, the procedures, the processes, and/or the activities of method 3500 can be performed in the order presented. In other embodiments, the procedures, the processes, and/or the activities of method 3500 can be performed in any suitable order. In still other embodiments, one or more of the procedures, the processes, and/or the activities of method 3500 can be combined or skipped.

In many embodiments, system 300 and/or the components thereof can be suitable to perform method 3500 and/or one or more of the operations, actions, and/or activities of method 3500. In these or other embodiments, one or more of the operations, actions, and/or activities of method 3500 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

Referring to FIG. 35, in many embodiments, method 3500 can involve various activities and/or interactions, such as messages, calls, or responses, between various systems and/or components, such as a user 3501, a payment service user interface 3502, a wallet user interface 3503, a payment service server 3504, a wallet server 3505, and/or a token service provider 3506. User 3501 can be similar or identical to user 321 (FIG. 3) and/or user device 320 (FIG. 3). Payment service user interface 3502 can be similar or identical to payment service user interface 3403 (FIG. 34). Wallet user interface 3503 can be similar or identical to wallet user interface 3402 (FIG. 34). Payment service server 3504 can be similar or identical to payment services server 360 (FIG. 3) and/or payment service server 3405 (FIG. 34). Wallet server 3505 can be similar or identical to wallet server 350 (FIG. 3) and/or wallet server 3404 (FIG. 34). Token service provider 3506 can be similar or identical to token service provider 370 (FIG. 3) and/or token service provider 3406 (FIG. 34).

In many embodiments, method 3500 can begin with user 3501 performing an activity 3510 of navigating to a payment instruments screen on payment service user interface 3502. For example, the payment instruments screen can be similar or identical to display screen 1000 (FIG. 10A). Method 3500 can next include payment service user interface 3502 making a call 3512 to payment service server 3504 to determine if the payment service account of the user in payment service server 3504 can link to a wallet in wallet server 3505. In some embodiments, call 3512 can include unique identifying information for the user, such as an email address, a phone number, and/or other suitable information. In some embodiments, such as when the user is in a checkout session, method 3500 can next include payment service server 3504 making a call 3514 to wallet server 3505 to get an OAuth token for the checkout session, after which wallet server 3505 can return a response 3516 of the token for the checkout session. Method 3500 can next include payment service server 3504 making a call 3518 to wallet server 3505 to determine if the payment service account of the user in payment service server 3504 can link to a wallet in wallet server 3505. In many embodiments, call 3518 can include unique identifying information for the user, such as an email address, a phone number, and/or other suitable information. Method 3500 can next include wallet server 3505 providing a response 3520 to payment service server 3504. In many embodiments, the response can indicate whether there is a wallet for the user that can be linked, and if so, can include a wallet ID and/or a wallet linking URL In some embodiments, as shown in an optional activity 3521, the identifier for the link (e.g., URL) can be sent in activity 3528, described below. Method 3500 can next include payment service server 3504 providing a response 3522 to payment service user interface 3502, which can include the information in response 3520. Method 3500 can next include an activity 3524 of payment service user interface 3502 displaying to user 3501 a button to link the wallet to the payment service. For example, activity 3524 can be similar or identical to displaying prompt 2930 (FIG. 29), and the button can be similar or identical to proceed button 2932 (FIG. 29).

In many embodiments, method 3500 can next include user 3501 performing an activity 3526 of tapping (or otherwise selecting) the button displayed on payment service user interface 3502 to link the wallet to the payment service. Method 3500 can next include payment service user interface 3502 performing an activity 3528 of redirecting the user device of the user to wallet user interface 3503, such as by using the wallet linking URL, for wallet user interface 3503 to display information for linking the wallet to the payment service. In many embodiments, the redirect can be a pop-up or a separate web page or other interface provided by wallet user interface 3503. Method 3500 can next include an activity 3530 of wallet user interface 3503 displaying an authentication (which can be similar or identical to verification code prompt 3030), and/or information about the linking (which can be similar or identical to prompt 3330 (FIG. 33)). In many embodiments, activity 3530 can include wallet user interface 3503 displaying terms and conditions and/or a service agreement for linking the wallet to the payment service account. Method 3500 can next include wallet user interface 3503 performing an activity 3532 of making a call to wallet server 3505 to link the wallet to the payment service account for the user.

In some embodiments, wallet server 3505 optionally can perform an activity 3533 of initiating an asynchronous process 3550 to get and store autofill tokens for the cards in the wallet of the user for subsequent use in autofill checkout at merchant websites displayed in the browser of the user, as described below in further detail. In many embodiments, method 3500 can next include wallet server 3505 making a call 3534 to payment service server 3504 to add cards from the wallet of the user in wallet server 3505 to the payment service account of the user in payment service server 3504. In many embodiments, call 3534 can include a link ID for the payment service account and card information for each payment card in the wallet of the user in wallet server 3505. In many embodiments, the card information can be similar or identical to the card information in call 3436 (FIG. 34). In many embodiments, payment service server 3504 can store this information in the payment service account for the user for linking the payment cards from the wallet of the user in wallet server 3505 into the payment service account of the user in payment service server 3504. Method 3500 can next include payment service server 3504 providing a response 3536 to wallet server 3505, after which wallet server 3505 can provide a response 3538 to wallet user interface 3503, after which wallet user interface 3503 can perform an activity 3540 of redirecting the user device back to payment service user interface 3502.

Method 3500 can next include payment service user interface 3502 making a call 3542 to payment service server 3504 to get information about the wallet cards that were stored in the payment service account of the user based on the linkage, after which payment service server 3504 can provide a response 3544 to payment service user interface 3502 that includes the information about the wallet cards. Method 3500 can next include an activity 3546 of payment service user interface displaying the wallet cards in the payment service user interface to user 3501.

Process 3550 to get and store autofill tokens for the cards in the wallet of the user for subsequent use in autofill checkout at merchant websites displayed in the browser of the user can be similar or identical to process 3450 (FIG. 34), described above. In many embodiments, process 3550 can be performed as a loop for each card in the wallet of the user in wallet server 3505. In many embodiments, process 3550 can include an activity 3552 of wallet server 3505 determining whether an autofill token is not already available for the card. If not, wallet server 3505 can make a call 3554 to token service provider 3506 to provision an autofill token for the card. Next, token service provider 3506 can provide a response 3556 to wallet server 3505, which can include information for the token, such as a TUR and/or other suitable information. In many embodiments, process 3550 can next include an activity 3558 of wallet server 3505 updating the card, such as updating the information about the token available for autofill checkout using the card.

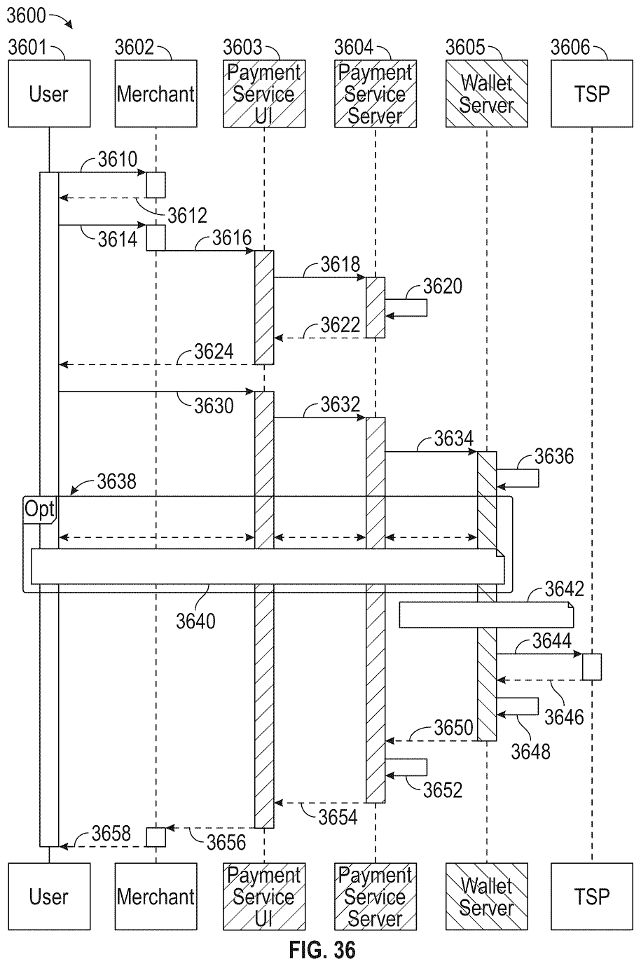

Turning ahead in the drawings, FIG. 36 illustrates a sequence diagram of a method 3600 of processing a checkout using the payment service. Method 3600 is merely exemplary and is not limited to the embodiments presented herein. Method 3600 can be employed in many different embodiments or examples not specifically depicted or described herein. In some embodiments, the procedures, the processes, and/or the activities of method 3600 can be performed in the order presented. In other embodiments, the procedures, the processes, and/or the activities of method 3600 can be performed in any suitable order. In still other embodiments, one or more of the procedures, the processes, and/or the activities of method 3600 can be combined or skipped.

In many embodiments, system 300 and/or the components thereof can be suitable to perform method 3600 and/or one or more of the operations, actions, and/or activities of method 3600. In these or other embodiments, one or more of the operations, actions, and/or activities of method 3600 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

Referring to FIG. 36, in many embodiments, method 3600 can involve various activities and/or interactions, such as messages, calls, or responses, between various systems and/or components, such as a user 3601, a merchant 3602, a payment service user interface 3603, a payment service server 3604, a wallet server 3605, and/or a token service provider 3606. User 3601 can be similar or identical to user 321 (FIG. 3) and/or user device 320 (FIG. 3). Merchant 3602 can be similar or identical merchant server to merchant server 330 and/or a user interface provided by merchant server, such as the user interface that generates the display screens shown in FIGS. 8A, 9A, and/or 26-33. Payment service user interface 3603 can be similar or identical to payment service user interface 3403 (FIG. 34) and/or payment service user interface 3502 (FIG. 35). Payment service server 3604 can be similar or identical to payment service server 360 (FIG. 3), payment service server 3405 (FIG. 34), and/or payment service server 3504 (FIG. 35). Wallet server 3605 can be similar or identical to wallet server 350 (FIG. 3), wallet server 3404 (FIG. 34), and/or wallet server 3505 (FIG. 35). Token service provider 3506 can be similar or identical to token service provider 370 (FIG. 3), token service provider 3406 (FIG. 34), and/or token service provider 3506 (FIG. 35).

In many embodiments, method 3600 can begin with user 3601 performing an activity 3610 of navigating to a checkout screen on a merchant user interface provided by merchant 3602. For example, the checkout screen can be similar or identical to display screen 800 (FIG. 8A), display screen 2600 (FIG. 26, and/or display screen 3200 (FIG. 32). Method 3600 can next include merchant 3602 performing an activity 3612 of displaying a payment service option. For example, the payment service option displayed by payment service user interface 3603 can be one of the options listed in payment selection prompt 810 (FIG. 8) and/or payment selection prompt 2610 (FIGS. 26 and/or 32). Method 3600 can next include an activity 3614 of user 3601 selecting the payment service on the user interface provided by merchant 3602. Method 3600 can next include an activity 3616 of merchant 3602 launching the payment service by redirecting to payment service user interface 3603. Method 3600 can next include payment service user interface 3603 making a call 3618 to payment service server 3604 to get the payment instruments that are stored in the payment service account of the user. Method 3600 can next include an activity 3620 of payment service server 3604 retrieving the payment instruments stored in the payment service account of the user in payment service server 3604. In many embodiments, once the wallet of the user has been linked to the payment service account of the user, as described above, the payment instruments retrieved by payment service server 3604 for the payment service account of the user can include the payment cards from the wallet of the user in wallet server 3605. Method 3600 can next include payment service server 3604 returning a result 3622 to payment service user interface 3603 that includes information or other data associated with the payment instruments determined in activity 3620, after which payment service user interface 3603 can perform an activity 3624 of displaying to user 3601 the payment instruments.

In many embodiments, method 3600 can next include user 3601 performing an activity 3630 of tapping (or otherwise selecting) a Wallet card instrument displayed on payment service user interface 3603. The Wallet card instrument can be a payment card that is stored in the payment service account of the user based on the linking of the wallet of the user with the payment service account. Method 3600 can next include payment service user interface 3603 making a call 3632 to payment service server 3604 to indicate that the Wallet card instrument, as identified by a Wallet card ID has been selected by the user for the purchase in the checkout transaction with merchant 3602. Method 3600 can next include an activity of payment service server 3604 making a call 3634 to wallet server 3605 to get a payload associated with the Wallet card ID. In many embodiments, call 3634 can specify that the request is for checking out with the payment service, and can additionally include additional details, such as device data for the user device and/or browser, transaction data for the transaction, and/or other suitable information. Method 3600 can next include wallet server 3605 performing an activity 3636 of running a risk analysis to determine whether to perform one or more step-up authentication procedures. If wallet server 3605 indicates that one or more step-up authentications procedures are to be performed, then optional process 3638 of step-up authentication can be performed.

Process 3638 for step-up authentication can include communications 3640 between the various system components to perform the one or more step-up authentication procedures. For example, an SMS OTP step-up authentication can be performed, which can involve sending an OTP code to user 3601 (e.g., to the user device associated with the phone number stored for the user) through an SMS message, and the user can be prompted to enter the OTP code, such as in payment service user interface 3603 provided by payment service server 3604 and/or in a user interface provided by wallet server 3605, and such OTP code can be used to authenticate the user. As another example, a verification value step-up authentication can be performed, which can involve requesting user 3601 to enter the verification value (e.g., CVV or CVC) for one or more of the payment cards in the wallet of the user. If validated, wallet server 3605 can perform an activity 3642 that acknowledges the successful completion of the step-up authentication process. In many embodiments, step-up authentication can additionally and/or alternatively be performed using a passkey based on FIDO standards, multi-factor authentication, biometric authentication, and/or other suitable authentication methods.

In many embodiments, following activity 3642 that includes confirmation of user verification, step-up authentication procedures and/or other authentication procedures, method 3600 can include wallet server 3605 making a call 3644 to token service provider 3606 to get payment data for the payment, after which token service provider 3606 can provide a response 3646 to wallet server 3605 containing the payment data. Next, method 3600 can include an activity 3648 of wallet server 3605 creating a secure payload, which can include a payment token for the ecommerce checkout transaction with merchant 3602, a cryptogram associated with the token, a token expiry for the token, a consumer name of user 3601, a billing address for user 3601, and/or other suitable information for merchant 3602 to process the transaction using payment tokenization. Payment tokenization can map the payment card stored in the wallet to a token that is used for the purchase in the checkout process with the merchant, to beneficially provide additional security. In many embodiments, the payload can be secured by wallet server 3605 encrypting the payload generated in activity 3648. Next, method 3600 can perform an activity 3650 of wallet server 3605 sending the secure payload to payment service server 3604, after which payment service server 3604 can perform an activity 3652 of decrypting the payload. Next, payment service server 3604 can perform an activity 3654 of sending the payload to payment service user interface 3603, after which payment service user interface 3603 can perform an activity 3656 of sending the payload to merchant 3602, after which merchant 3602 can perform an activity 3658 of displaying the token information to user 3601 in the merchant user interface provided by merchant 3602. With the token information, merchant 3602 can process the checkout transaction.

In many embodiments, various methods (similar to method 3600) can support and help facilitate a cross-border transaction such as between a user and merchant that are located in different jurisdictions or regions. For example, a user located outside of the United States can perform an activity of navigating to a checkout screen on a merchant user interface (e.g., merchant website) provided by a merchant located in the United States. The method can further comprise the merchant performing an activity of displaying a payment service option which then prompts an activity of the user selecting the payment service on the user interface provided by the merchant. The method can further comprise an activity of the merchant launching the payment service by redirecting to the payment service user interface. By way of example, the payment service user interface can be hosted in the same jurisdiction and/or region as the merchant (e.g., in the United States) and the payment service user interface can make a call to a payment service server located in a different jurisdiction and/or region as the merchant (e.g., outside the United States) to get the payment instruments that are stored in the payment service account of the user. The method can further comprise an activity of the payment service server retrieving the payment instruments stored in the payment service account of the user in the payment service server. In many embodiments, once the wallet of the user has been linked to the payment service account of the user, as described above, the payment instruments retrieved by the payment service server for the payment service account of the user can comprise the payment cards from the wallet of the user in a wallet server located in a different jurisdiction and/or region as the merchant (e.g., outside the United States). The method can further comprise the payment service server returning a result to payment service user interface that comprises information or other data associated with the payment instruments determined or otherwise retrieved from the payment service account of the user in the payment service account, after which the payment service user interface can perform an activity of displaying to user the payment instruments available to use during the transaction. It will be understood that a similar method can support and/or help facilitate a transaction between a user located in the United States and merchant located outside of the United States.

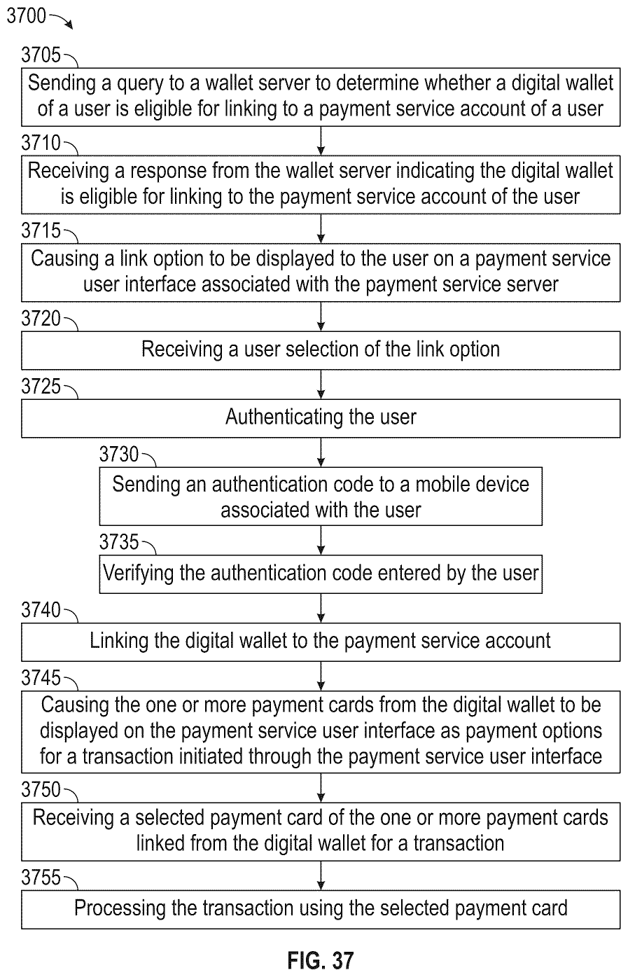

Turning ahead in the drawings, FIG. 37 illustrates a flowchart for a method 3700 of linking a digital wallet within a separate payment service, according to an embodiment. Method 3700 is merely exemplary and is not limited to the embodiments presented herein. Method 3700 can be employed in many different embodiments or examples not specifically depicted or described herein. In some embodiments, the procedures, the processes, and/or the activities of method 3700 can be performed in the order presented. In other embodiments, the procedures, the processes, and/or the activities of method 3700 can be performed in any suitable order. In still other embodiments, one or more of the procedures, the processes, and/or the activities of method 3700 can be combined or skipped.

In many embodiments, payment service server 360 (FIG. 3), payment service server 3405 (FIG. 34), payment service server 3504 (FIG. 35), and/or payment service server 3604 (FIG. 36) can be suitable to perform method 3700 and/or one or more of the activities of method 3700. In these or other embodiments, one or more of the activities of method 3700 can be implemented as one or more computing instructions configured to run at one or more processors and configured to be stored at one or more non-transitory computer readable media. Such non-transitory computer readable media can be part of payment service server 360 (FIG. 3), payment service server 3405 (FIG. 34), payment service server 3504 (FIG. 35), and/or payment service server 3604 (FIG. 36). The processor(s) can be similar or identical to the processor(s) described above with respect to computer system 100 (FIG. 1). In some embodiments, method 3700 and other activities in method 3700 can include using a distributed network including distributed memory architecture to perform the associated activity. This distributed architecture can reduce the impact on the network and system resources to reduce congestion in bottlenecks while still allowing data to be accessible from a central location.

Referring to FIG. 37, method 3700 can include an activity 3705 of sending, by a payment service server to a wallet server, a query to determine whether a digital wallet of a user is eligible for linking to a payment service account of a user. The payment service server can be similar or identical to payment service server 360 (FIG. 3), payment service server 3405 (FIG. 34), payment service server 3504 (FIG. 35), and/or payment service server 3604 (FIG. 36). The wallet server can be similar or identical to wallet server 350 (FIG. 3), wallet server 3404 (FIG. 34), wallet server 3505 (FIG. 35), and/or wallet server 3605 (FIG. 36). The query can be similar or identical to activity 412 (FIG. 4), activity 416 (FIG. 4), call 3412 (FIG. 34), activity 3414 (FIG. 34), and/or call 3518 (FIG. 35). The user can be similar or identical to user 321 (FIG. 3), user 3401 (FIG. 34), user 3501 (FIG. 35), and/or user 3601 (FIG. 36). The digital wallet can be similar or identical to the wallet for each user stored in the wallet directory of the wallet server, such as in wallet server 350 (FIG. 3). The payment service account can be similar or identical to the account of each user stored in the payment service server, such as payment service server 360 (FIG. 3).

In several embodiments, method 3700 also can include an activity 3710 of receiving, by the payment service server from the wallet server, a response indicating the digital wallet is eligible for linking to the payment service account of the user. The response can be similar or identical to response 418 (FIG. 4), result 3416 (FIG. 34), and/or response 3520 (FIG. 35).

In several embodiments, method 3700 additionally can include an activity 3715 of causing a link option to be displayed to the user on a payment service user interface associated with the payment service server. Activity 3715 can be similar or identical to activity 422 (FIG. 4), activity 3418 (FIG. 34), and/or activity 3524 (FIG. 35). The link option can be similar or identical to display screen 1600 (FIG. 16), display screen 1800 (FIG. 18), and/or prompt 2930 (FIG. 29).

In several embodiments, method 3700 further can include an activity 3720 of receiving, by the payment service server, a user selection of the link option. Activity 3720 can be similar or identical to activity 510 (FIG. 5), activity 3420 (FIG. 34), activity 3422 (FIG. 34), activity 3526 (FIG. 35), and/or activity 3528 (FIG. 35).

In several embodiments, method 3700 additionally can include an activity 3725 of authenticating the user, which in many embodiments can occur prior to activity 3740 (described below) of linking the digital wallet to the payment service account. Activity 3725 can be similar or identical to activity 410 (FIG. 4), activity 516 (FIG. 5), activity 3424 (FIG. 34), activity 3530 (FIG. 35), and/or process 3638 (FIG. 36).

In several embodiments, activity 3725 of authenticating the user can include an activity 3730 of sending an authentication code to a mobile device associated with the user. The authentication code can be an OTP or other code, such as the authentication code entered in authentication code field 1220 (FIG. 12) and/or input field 3031 (FIG. 31).

In several embodiments, activity 3725 of authenticating the user also can include an activity 3735 of verifying the authentication code entered by the user. Activity 3735 can be similar or identical to activity 518 (FIG. 5).

In several embodiments, method 3700 further can include an activity 3740 of linking, by the payment service server, the digital wallet to the payment service account. In many embodiments, activity 3740 can include storing, in the payment service account, information for one or more payment cards from the digital wallet. The information can be similar to card information 522 (FIG. 5). In many embodiments, the information for the one or more payment cards can include a respective token for each of the one or more payment cards in the digital wallet. In many embodiments, the wallet server can request the respective token for each of the one or more payment cards in the digital wallet from a token service provider. The token service provider can be similar or identical to token service provider 370 (FIG. 3), token service provider 3406 (FIG. 34), token service provider 3506 (FIG. 35), and/or token service provider 3606 (FIG. 36). Activity 3740 can be similar or identical to call 3436 (FIG. 34) and/or call 3534 (FIG. 35).

In several embodiments, method 3700 additionally can include an activity 3745 of causing, by the payment service server, the one or more payment cards from the digital wallet to be displayed on the payment service user interface as payment options for a transaction initiated through the payment service user interface. Activity 3745 can be similar or identical to activity 524 (FIG. 5) and/or activity 3546 (FIG. 35). The display of the payment cards can be similar or identical to display screen 1000 (FIG. 10).

In several embodiments, method 3700 further can include an activity 3750 of receiving, by the payment service server, a selected payment card of the one or more payment cards linked from the digital wallet for a transaction. Activity 3750 can be similar or identical to activity 3630 (FIG. 36).

In several embodiments, method 3700 additionally can include an activity 3755 of facilitating processing the transaction using the selected payment card, such as sending a payload associated with the selected payment card to a merchant (e.g., merchant 3602 (FIG. 36)) to process the transaction.

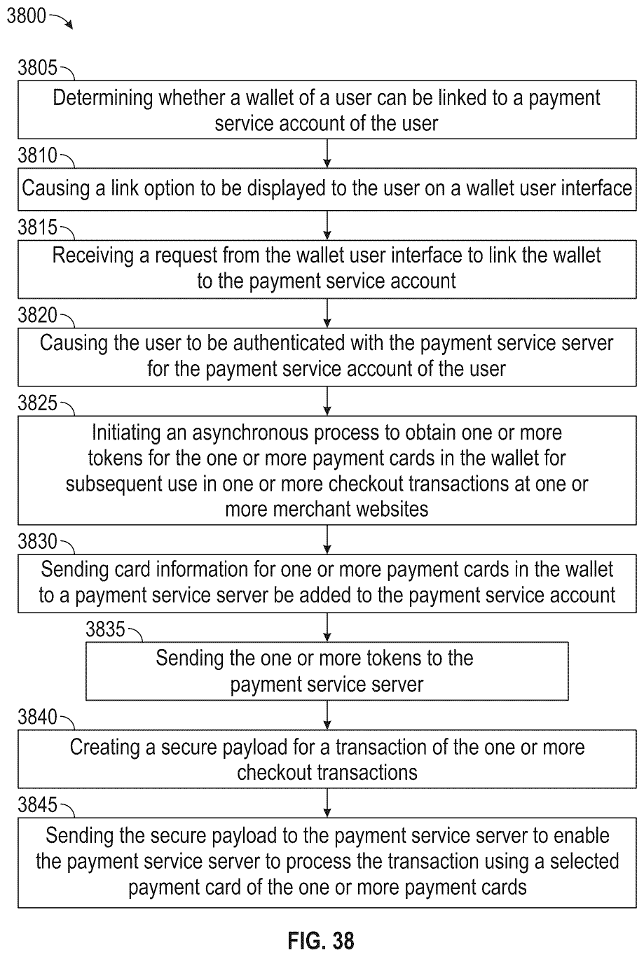

Turning ahead in the drawings, FIG. 38 illustrates a flowchart for a method 3800 of linking a digital wallet within a separate payment service, according to an embodiment. Method 3800 is merely exemplary and is not limited to the embodiments presented herein. Method 3800 can be employed in many different embodiments or examples not specifically depicted or described herein. In some embodiments, the procedures, the processes, and/or the activities of method 3800 can be performed in the order presented. In other embodiments, the procedures, the processes, and/or the activities of method 3800 can be performed in any suitable order. In still other embodiments, one or more of the procedures, the processes, and/or the activities of method 3800 can be combined or skipped.

In many embodiments, wallet server 350 (FIG. 3), wallet server 3404 (FIG. 34), wallet server 3505 (FIG. 35), and/or wallet server 3605 (FIG. 36) can be suitable to perform method 3800 and/or one or more of the activities of method 3800. In these or other embodiments, one or more of the activities of method 3800 can be implemented as one or more computing instructions configured to run at one or more processors and configured to be stored at one or more non-transitory computer readable media. Such non-transitory computer readable media can be part of wallet server 350 (FIG. 3), wallet server 3404 (FIG. 34), wallet server 3505 (FIG. 35), and/or wallet server 3605 (FIG. 36). The processor(s) can be similar or identical to the processor(s) described above with respect to computer system 100 (FIG. 1). In some embodiments, method 3800 and other activities in method 3800 can include using a distributed network including distributed memory architecture to perform the associated activity. This distributed architecture can reduce the impact on the network and system resources to reduce congestion in bottlenecks while still allowing data to be accessible from a central location.

Referring to FIG. 38, method 3800 can include an activity 3805 of determining, by a wallet server, whether a wallet of a user can be linked to a payment service account of the user. The wallet server can be similar or identical to wallet server 350 (FIG. 3), wallet server 3404 (FIG. 34), wallet server 3505 (FIG. 35), and/or wallet server 3605 (FIG. 36). The payment service server can be similar or identical to payment service server 360 (FIG. 3), payment service server 3405 (FIG. 34), payment service server 3504 (FIG. 35), and/or payment service server 3604 (FIG. 36). The user can be similar or identical to user 321 (FIG. 3), user 3401 (FIG. 34), user 3501 (FIG. 35), and/or user 3601 (FIG. 36). The wallet can be similar or identical to the wallet for each user stored in the wallet directory of the wallet server, such as in wallet server 350 (FIG. 3). The payment service account can be similar or identical to the account of each user stored in the payment service server, such as payment service server 360 (FIG. 3). Activity 3805 can be similar or identical to activity 416 (FIG. 4), call 3412 (FIG. 34), activity 3414 (FIG. 34), and/or call 3518 (FIG. 35). In some embodiments, activity 3805 can include determining whether the payment service account of the user exists based on contact information for the user stored in the wallet of the user.

In several embodiments, method 3800 also can include an activity 3810 of causing a link option to be displayed to the user on a wallet user interface. Activity 3810 can be similar or identical to activity 422 (FIG. 4), activity 3418 (FIG. 34), and/or activity 3524 (FIG. 35). The link option can be similar or identical to display screen 1600 (FIG. 16), display screen 1800 (FIG. 18), and/or prompt 2930 (FIG. 29). The wallet user interface can be similar or identical to wallet user interface 3402 (FIG. 34) and/or wallet user interface 3503 (FIG. 35).

In several embodiments, method 3800 additionally can include an activity 3815 of receiving, at the wallet server from the wallet user interface, a request to link the wallet to the payment service account. Activity 3815 can be similar or identical to activity 3422 (FIG. 34) and/or activity 3532 (FIG. 35).

In several embodiments, method 3800 further can include an activity 3820 of causing the user to be authenticated with the payment service server for the payment service account of the user. Activity 3820 can be similar or identical to causing activities 3422 and/or 3424 (FIG. 34) to be performed.

In several embodiments, method 3800 additionally can include an activity 3825 of initiating an asynchronous process to obtain one or more tokens for the one or more payment cards in the wallet for subsequent use in one or more checkout transactions at one or more merchant websites. Activity 3825 can be similar or identical to activity 3434 (FIG. 34). In some embodiments, the one or more tokens can be one or more autofill tokens.

In several embodiments, method 3800 further can include an activity 3830 of sending, by the wallet server, card information for one or more payment cards in the wallet to a payment service server be added to the payment service account. Activity 3830 can be similar or identical to call 3436 (FIG. 34).

In several embodiments, method 3800 or activity 3830 can include an activity 3835 of sending the one or more tokens to the payment service server. In some embodiments, the tokens can be obtained from a token service provider. The token service provider can be similar or identical to token service provider 370 (FIG. 3), token service provider 3406 (FIG. 34), token service provider 3506 (FIG. 35), and/or token service provider 3606 (FIG. 36).

In several embodiments, method 3800 further can include an activity 3840 of creating a secure payload for a transaction of the one or more checkout transactions. In some embodiments, activity 3840 can be similar or identical to activity 3648 (FIG. 36).

In several embodiments, method 3800 additionally can include an activity 3845 of sending the secure payload to the payment service server to enable the payment service server to process the transaction using a selected payment card of the one or more payment cards. In some embodiments, activity 3845 can be similar or identical to activity 3650 (FIG. 36).

Although systems and methods for linking a digital wallet within a separate payment service has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 1-36 may be modified, and that the foregoing discussion of certain of these embodiments does not necessarily represent a complete description of all possible embodiments. For example, one or more of the procedures, processes, or activities of FIGS. 4-7 and/or 34-38 may include different procedures, processes, and/or activities and be performed by many different modules, in many different orders. As another example, the components within system 300 of FIG. 3 can be interchanged or otherwise modified. In one non-limiting example, one or more of the procedures, processes, and/or activities performed by system 300 can bypass the browser server 340 such that the payment service server 360 communicates directly with the browser used by the user during a transaction. In such example, the browser can be embedded with transaction functionality that enables the payment service server 360 to interact directly with the transaction functionality of the browser to perform the transaction by the user.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
determining, by a wallet server, whether a wallet of a user can be linked to a payment service account of the user;
causing a link option to be displayed to the user on a wallet user interface;
receiving, at the wallet server from the wallet user interface, a request to link the wallet to the payment service account; and
sending, by the wallet server, card information for one or more payment cards in the wallet to a payment service server be added to the payment service account.

2. The computer-implemented method of claim 1, wherein determining whether the wallet can be linked to the payment service account of the user comprises determining whether the payment service account of the user exists based on contact information for the user stored in the wallet of the user.

3. The computer-implemented method of claim 1 further comprising, before sending the card information for the one or more payment cards to the payment service server:
causing the user to be authenticated with the payment service server for the payment service account of the user.

4. The computer-implemented method of claim 1 further comprising, before sending the card information for the one or more payment cards to the payment service server:
initiating an asynchronous process to obtain one or more tokens for the one or more payment cards in the wallet for subsequent use in one or more checkout transactions at one or more merchant websites.

5. The computer-implemented method of claim 4 further comprising:
sending the one or more tokens to the payment service server.

6. The computer-implemented method of claim 4, wherein the tokens are obtained from a token service provider.

7. The computer-implemented method of claim 4 further comprising:
creating a secure payload for a transaction of the one or more checkout transactions; and
sending the secure payload to the payment service server to enable the payment service server to process the transaction using a selected payment card of the one or more payment cards.

8. A system comprising one or more processors and one or more non-transitory computer-readable media storing computing instructions that, when executed on the one or more processors, cause the one or more processors to perform operations comprising:
determining whether a wallet of a user can be linked to a payment service account of the user;
causing a link option to be displayed to the user on a wallet user interface;
receiving, from the wallet user interface, a request to link the wallet to the payment service account; and
sending card information for one or more payment cards in the wallet to a payment service server be added to the payment service account.

9. The system of claim 8, wherein determining whether the wallet can be linked to the payment service account of the user comprises determining whether the payment service account of the user exists based on contact information for the user stored in the wallet of the user.

10. The system of claim 8, wherein the operations further comprise, before sending the card information for the one or more payment cards to the payment service server:
causing the user to be authenticated with the payment service server for the payment service account of the user.

11. The system of claim 8, wherein the operations further comprise, before sending the card information for the one or more payment cards to the payment service server:
initiating an asynchronous process to obtain one or more tokens for the one or more payment cards in the wallet for subsequent use in one or more checkout transactions at one or more merchant websites.

12. The system of claim 11, wherein the operations further comprise:
sending the one or more tokens to the payment service server.

13. The system of claim 11, wherein the tokens are obtained from a token service provider.

14. The system of claim 11, wherein the operations further comprise:
creating a secure payload for a transaction of the one or more checkout transactions; and
sending the secure payload to the payment service server to enable the payment service server to process the transaction using a selected payment card of the one or more payment cards.

15. One or more non-transitory computer-readable media storing computing instructions that, when executed on one or more processors, cause the one or more processors to perform operations comprising:
determining whether a wallet of a user can be linked to a payment service account of the user;
causing a link option to be displayed to the user on a wallet user interface;
receiving, from the wallet user interface, a request to link the wallet to the payment service account; and
sending card information for one or more payment cards in the wallet to a payment service server be added to the payment service account.

16. The one or more non-transitory computer-readable media of claim 15, wherein determining whether the wallet can be linked to the payment service account of the user comprises determining whether the payment service account of the user exists based on contact information for the user stored in the wallet of the user.

17. The one or more non-transitory computer-readable media of claim 15, wherein the operations further comprise, before sending the card information for the one or more payment cards to the payment service server:
causing the user to be authenticated with the payment service server for the payment service account of the user.

18. The one or more non-transitory computer-readable media of claim 15, wherein the operations further comprise, before sending the card information for the one or more payment cards to the payment service server:
initiating an asynchronous process to obtain one or more tokens for the one or more payment cards in the wallet for subsequent use in one or more checkout transactions at one or more merchant websites.

19. The one or more non-transitory computer-readable media of claim 18, wherein the operations further comprise:
sending the one or more tokens to the payment service server.

20. The one or more non-transitory computer-readable media of claim 18, wherein the operations further comprise:
creating a secure payload for a transaction of the one or more checkout transactions; and
sending the secure payload to the payment service server to enable the payment service server to process the transaction using a selected payment card of the one or more payment cards.
